(19) United States
(12) Patent Application Publication
(10) Pub. No.: US 2017/0090909 A1
(43) Pub. Date: Mar. 30, 2017

(54) SECURE PATCH UPDATES FOR PROGRAMMABLE MEMORIES

(71) Applicant: QUALCOMM Incorporated, San Diego, CA (US)

(72) Inventors: Xu GUO, San Diego, CA (US); Ron KEIDAR, San Diego, CA (US); Rodney ZIOLKOWSKI, Del Mar, CA (US); Mahesh Dandapani IYER, Saratoga, CA (US); Yau CHU, Milpitas, CA (US)

(21) Appl. No.: 14/866,682

(22) Filed: Sep. 25, 2015

(51) Int. Cl. G06F 9/445; G06F 21/57

(52) U.S. Cl. CPC G06F 8/66; G06F 21/575; G06F 2221/033

(57) ABSTRACT

Methods, apparatus, and computer program products for securely writing patch code to a memory of a system-on-chip (SoC) are described. An example of a method for securely writing patch code to the memory of the SoC includes determining an authentication status of a patch code image, if the authentication status of the patch code image is authenticated, then writing the patch code from the patch code image into a one-time programmable (OTP) memory and generating a system reset signal, and if the authentication status of the patch code image is unauthenticated, then booting the SoC without writing the patch code from the patch code image into the OTP memory.

### TECHNICAL FIELD

This disclosure document describes technology generally related to security systems for electronic devices, and more specifically to methods, systems, and devices for secure patch updates for previously programmed memories. Certain aspects enable and provide costs and efforts associated with updating previously programmed memories (e.g., read-only memories or ROMs).

### INTRODUCTION

An as-manufactured system-on-chip (SoC) includes code stored in a read-only memory (ROM). Typically, code stored in ROM includes pre-boot loader (PBL) and other bootstrapping instructions. Storing the PBL and other bootstrapping instructions in ROM is preferred for security reasons because once the SoC is manufactured, the ROM cannot be changed. Therefore, instructions stored in ROM are generally considered to be secure and trusted code. When a processor boots up after a power-down or reset, an initialization process can include patching areas of ROM on the SoC with instructions and/or data that corrects known problems or adds additional capability. Typically, to implement ROM code patching without re-masking, a chip manufacturer programs patch code and configuration instructions into a one-time programmable (OTP) memory that resides on the SoC.

### BRIEF SUMMARY OF SOME EXAMPLES

The following summarizes some aspects of the present disclosure to provide a basic understanding of the discussed technology. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Items and/or techniques described herein may provide one or more of the following capabilities, as well as other capabilities not mentioned. Patch code may be securely stored in a SoC after manufacturing. A manufacturer may ship a SoC in a secure state with write access to an OTP memory disabled. A patch code image may be subsequently provided to the SoC. The SoC may authenticate the patch code image during execution of Primary Boot Loader (PBL) firmware at power-on reset. The patch code may correspond to the PBL firmware and/or other code stored in ROM. The SoC may conditionally store the patch code in the OTP memory based on the authentication of the patch code image. In a case of an authenticated image, the SoC may enable write access to the OTP memory. Subsequent to storage of the patch code in the OTP memory, the SoC may disable further access to the OTP memory. In this manner, firmware stored in ROM may be securely patched during a boot process after manufacturing. Security attributes generally provided by the initial ROM storage may be retained. The SoC may controllably enable and disable write access to a content addressable memory (CAM) based on the authentication of the patch code image. Write access to the CAM may enable modification of a patching table stored in the CAM. Other capabilities may be provided and not every implementation according to the disclosure must provide any, let alone all, of the capabilities discussed. Further, it may be possible for an effect noted above to be achieved by means other than that noted and a noted item/technique may not necessarily yield the noted effect.

An example of a method for securely writing patch code to a memory of a system-on-chip (SoC) according to the disclosure may include determining an authentication status of a patch code image, if the authentication status of the patch code image is authenticated, then writing the patch code from the patch code image into a one-time programmable (OTP) memory and generating a system reset signal, and if the authentication status of the patch code image is unauthenticated, then booting the SoC without writing the patch code from the patch code image into the OTP memory.

Implementations of such a method may include one or more of the following features. The method may include receiving the patch code image post-manufacturing via a signal received at the SoC. The method may include, in response to the system reset signal, executing primary boot loader (PBL) firmware stored in read-only memory and replacing at least a portion of the PBL firmware with the patch code written to the OTP memory. The method may include determining the authentication status of the patch code image during execution of pre-boot loader code and based at least in part on a digital signature and a public key. The method may include, in response to the patch code being written into the OTP memory, writing a lock value to at least one of a fuse device or a one-time writable register (OWR) and determining an output of a write access control circuit to be indicative of a disallowed write access for the OTP memory based on the written lock value. The method may include, if the authentication status of the patch code image is authenticated, then writing an unlock value to at least one one-time writable register (OWR) and determining an output of a write access control circuit to be indicative of an allowed write access for the OTP memory and, if the authentication status of the patch code image is unauthenticated, then writing a lock value to the at least one one-time writable register (OWR) and determining the output of the write access control circuit to be indicative of a disallowed write access for the OTP memory. The method may include, if the authentication status of the patch code image is authenticated, then writing an unlock value to at least one register and determining an output of a write access control circuit to be indicative of an allowed write access for the OTP memory and, if the authentication status of the patch code image is unauthenticated, then writing a lock value to at least one one-time writable register (OWR) and determining the output of the write access control circuit to be indicative of a disallowed write access for the OTP memory. The method may include providing temporarily disabled write access to at least a portion of the OTP memory prior to the determining the authentication status and, if the authentication status of the patch code image is authenticated, then providing temporarily enabled write access to the at least the portion of the OTP memory.

An example of a security system for an electronic device that includes a system-on-chip (SoC) according to the disclosure may include an on-chip memory that includes a one-time programmable (OTP) memory and a processor configured to determine an authentication status of a patch code image, if the authentication status of the patch code image is authenticated, then write patch code from the patch code image into a one-time programmable (OTP) memory and generate a system reset signal, and, if the authentication status of the patch code image is unauthenticated, then boot the SoC without writing the patch code from the patch code image into the OTP memory.

Implementations of such a security system may include one or more of the following features. The SoC may further include a communications interface configured to receive the patch code image post-manufacturing via a signal received at the SoC. The processor may be further configured to, in response to the system reset signal, execute primary boot loader (PBL) firmware stored in read-only memory; and replace at least a portion of the PBL firmware with the patch code written to the OTP memory. The processor may be further configured to determine the authentication status of the patch code image during execution of pre-boot loader code and based at least in part on a digital signature and a public key. The processor may be further configured to, in response to the patch code being written into the OTP memory, write a lock value to at least one of a fuse device or a one-time writable register (OWR) and determine an output of a write access control circuit to be indicative of a disallowed write access for the OTP memory based on the written lock value. The processor may be further configured to, if the authentication status of the patch code image is authenticated, then write an unlock value to at least one one-time writable register (OWR) and determine an output of a write access control circuit to be indicative of an allowed write access for the OTP memory, and, if the authentication status of the patch code image is unauthenticated, then write a lock value to the at least one one-time writable register (OWR) and determine the output of the write access control circuit to be indicative of a disallowed write access for the OTP memory. The processor may be further configured to, if the authentication status of the patch code image is authenticated, then write an unlock value to at least one register and determine an output of a write access control circuit to be indicative of an allowed write access for the OTP memory, and, if the authentication status of the patch code image is unauthenticated, then write a lock value to at least one one-time writable register (OWR) and determine the output of the write access control circuit to be indicative of a disallowed write access for the OTP memory. The processor may include a write access control circuit configured to provide temporarily disabled write access to at least a portion of the OTP memory prior to the determination of the authentication status, and if the authentication status of the patch code image is authenticated, then provide temporarily enabled write access to the at least the portion of the OTP memory.

An example of a system-on-chip (SoC) according to the disclosure may include means for determining an authentication status of a patch code image, means for writing patch code from the patch code image into a one-time programmable (OTP) memory and means for generating a system reset signal if the authentication status of the patch code image is authenticated, and means for booting the SoC without writing the patch code from the patch code image into the OTP memory if the authentication status of the patch code image is unauthenticated.

Implementations of such a SoC may include one or more of the following features. The SoC may further include means for receiving the patch code image post-manufacturing via a signal received at the SoC. The SoC may further include means for executing primary boot loader (PBL) firmware stored in read-only memory in response to the system reset signal and means for replacing at least a portion of the PBL firmware with the patch code written to the OTP memory. The SoC may further include means for determining the authentication status of the patch code image during execution of pre-boot loader code and based at least in part on a digital signature and a public key. The SoC may further include means for writing a lock value to at least one of a fuse device or a one-time writable register (OWR) in response to the writing the patch code into the OTP memory and means for determining an output of a write access control circuit to be indicative of a disallowed write access for the OTP memory based on the written lock value. The SoC may further include means for writing an unlock value to at least one one-time writable register (OWR) and means for determining an output of a write access control circuit to be indicative of an allowed write access for the OTP memory if the authentication status of the patch code image is authenticated and means for writing a lock value to the at least one one-time writable register (OWR) and means for determining the output of the write access control circuit to be indicative of a disallowed write access for the OTP memory if the authentication status of the patch code image is unauthenticated. The SoC may further include means for writing an unlock value to at least one register and means for determining an output of a write access control circuit to be indicative of an allowed write access for the OTP memory if the authentication status of the patch code image is authenticated and means for writing a lock value to at least one one-time writable register (OWR) and means for determining the output of the write access control circuit to be indicative of a disallowed write access for the OTP memory if the authentication status of the patch code image is unauthenticated. The SoC may further include means for providing temporarily disabled write access to at least a portion of the OTP memory prior to the determining the authentication status and means for providing temporarily enabled write access to the at least the portion of the OTP memory if the authentication status of the patch code image is authenticated.

An example of a computer program product according to the disclosure may include processor-readable instructions configured to cause a processor to determine an authentication status of a patch code image, if the authentication status of the patch code image is authenticated, then write patch code from the patch code image into a one-time programmable (OTP) memory and generate a system reset signal, and if the authentication status of the patch code image is unauthenticated, then boot the SoC without writing the patch code from the patch code image into the OTP memory.

Implementations for such a computer program product may include one or more of the following features. The processor-readable instructions may be further configured to cause the processor to receive the patch code image post-manufacturing via a signal received at the SoC. The processor-readable instructions may be further configured to cause the processor to in response to the system reset signal, execute primary boot loader (PBL) firmware stored in read-only memory, and replace at least a portion of the PBL firmware with the patch code written to the OTP memory. The processor-readable instructions may be further configured to cause the processor to determine the authentication status of the patch code image during execution of pre-boot loader code and based at least in part on a digital signature and a public key. The processor-readable instructions may be further configured to cause the processor to, in response to the patch code being written into the OTP memory, write a lock value to at least one of a fuse device or a one-time writable register (OWR) and determine an output of a write access control circuit to be indicative of a disallowed write access for the OTP memory based on the written lock value. The processor-readable instructions may be further configured to cause the processor to, if the authentication status of the patch code image is authenticated, then write an unlock value to at least one one-time writable register (OWR) and determine an output of a write access control circuit to be indicative of an allowed write access for the OTP memory and, if the authentication status of the patch code image is unauthenticated, then write a lock value to the at least one one-time writable register (OWR) and determine the output of the write access control circuit to be indicative of a disallowed write access for the OTP memory. The processor-readable instructions may be further configured to cause the processor to, if the authentication status of the patch code image is authenticated, then write an unlock value to at least one register and determine an output of a write access control circuit to be indicative of an allowed write access for the OTP memory and, if the authentication status of the patch code image is unauthenticated, then write a lock value to at least one one-time writable register (OWR) and determine the output of the write access control circuit to be indicative of a disallowed write access for the OTP memory. The processor-readable instructions may be further configured to cause the processor to provide temporarily disabled write access to at least a portion of the OTP memory prior to the determination of the authentication status and, if the authentication status of the patch code image is authenticated, then provide temporarily enabled write access to the at least the portion of the OTP memory.

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments discussed herein. In similar fashion, while exemplary embodiments may be discussed below as device, system, or method embodiments it should be understood that such exemplary embodiments can be implemented in various devices, systems, and methods.

### BRIEF DESCRIPTIONS OF THE DRAWINGS

FIG. 1 is a block diagram of hardware components of a SoC system according to some aspects/embodiments.

FIG. 2 is a schematic diagram of a code image according to some aspects/embodiments.

FIG. 3 is a symbolic logic representation of an example of a write access control system for an OTP memory according to some aspects/embodiments.

FIGS. 4A and 4B are examples of truth tables for the logic functions of the write access control system in FIG. 3 according to some aspects/embodiments.

FIG. 5 is a symbolic logic representation of an example of a write access control system for an OTP memory according to some aspects/embodiments.

FIGS. 6A and 6B are examples of truth tables for the logic functions of the write access control system in FIG. 5 according to some aspects/embodiments.

FIG. 7 is a state transition diagram based on the write access control system of FIG. 3 according to some aspects/embodiments.

FIG. 8 is a state transition diagram based on the write access control system of FIG. 5 according to some aspects/embodiments.

FIGS. 9 and 10 are symbolic logic representations of examples of write access control systems for a CAM according to some aspects/embodiments.

FIG. 11 is an example of a truth table for the logic functions of the AND gates shown in FIGS. 9 and 10 according to some aspects/embodiments.

FIGS. 12 and 13 are block diagrams of methods of securely updating/writing patch code to an OTP memory of the SoC according to some aspects/embodiments.

### DETAILED DESCRIPTION

Techniques are provided for securely updating and/or writing patch code into a memory of a SoC. The techniques discussed below are exemplary, however, and not limiting as other implementations in accordance with the disclosure are possible. The described techniques may be implemented as a method, apparatus, or system and can be embodied in processor-readable media.

Authentication of a patch code image is performed by a processor. Authentication is verification that the patch code image originates from a trusted source (e.g., based on a root-of-trust). For example, the patch code image may be authenticated based on patch information in the patch code image and on a public key stored in the SoC by the chip manufacturer. The patch code image may be authenticated during execution of PBL firmware. The processor may be configured to write an unlock value to a register if the patch code image is authenticated. The register may be a one-time writable register (OWR). Further, the processor may be configured to write a lock value to the register if the patch code image is unauthenticated. Based on the authentication status of the patch code image, the patch code is either stored in a one-time programmable (OTP) memory or the SoC is booted without storing the patch code. Requiring authentication of the patch code image prior to writing the patch code into the OTP memory is a security mechanism that may prevent malicious and/or unauthorized programming of the OTP memory. Once authenticated patch code is stored in the OTP memory, the processor may be configured to write a lock value to another register to disallow further write access to the OTP memory. The OTP memory region may be locked after manufacturing with the capability of being unlocked based on the authentication status of the patch code image and the values stored in the registers. In this manner, the processor may securely store an authenticated patch code image post-manufacturing.

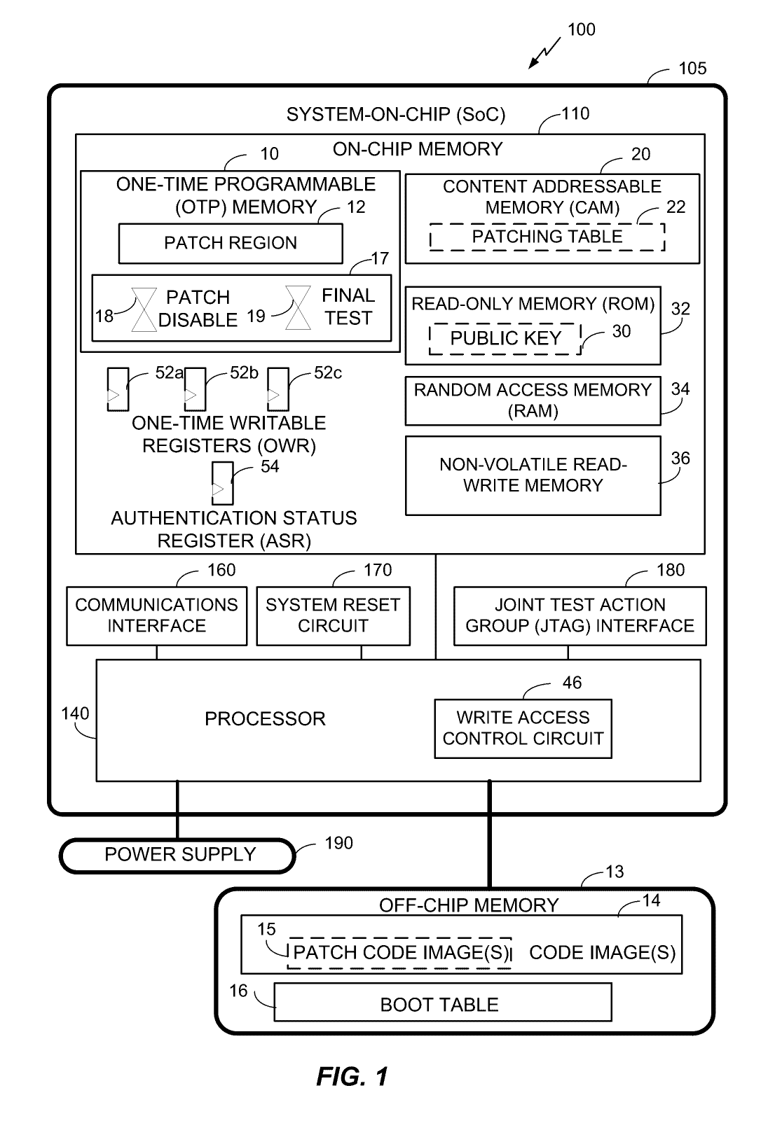

Referring to FIG. 1, a block diagram of hardware components of a SoC system according to some aspects/embodiments is shown. A quantity of each component in FIG. 1 is an example only and other quantities of each, or any, component could be used. The SoC system 100 can be part of an electronic system, or end device, not shown in FIG. 1. The end device may be an electronic system that includes ICs, for example, but not limited to mainframes, mini-computers, servers, workstations, set-top boxes, personal computers, laptop computers, mobile devices, hand-held devices, wireless devices, tablets, modems, electronic readers, personal digital assistants, electronic games, automobiles and automobile components, aircraft, machinery, entertainment devices, medical devices, Internet of Things (IoT)/Internet of Everything (IoE) enabled devices, manufacturing devices, and embedded systems. As discussed below, the SoC system 100 can operate in a variety of wired/wireless communication systems and networks. An example of the SoC system 100 includes off-chip components and on-chip components. Any or all of the hardware components may be implemented as a number of separate integrated circuits or separate devices interconnected with each other. On-chip components may be implemented as off-chip components communicatively coupled to one another and/or to other on-chip components of the SoC 105.

The off-chip components include an off-chip memory 13 and a power supply 190. The power supply 190 is coupled to the SoC 105. For example, the power supply may be coupled to the processor 140. The off-chip memory 13 (e.g., a first non-volatile read-write memory, an off-chip non-volatile read-write memory, an off-chip flash memory, an embedded multi-media card (eMMC)) can be a non-volatile read-write memory. The off-chip memory 13 can be coupled to the processor 140. The off-chip memory 13 may include a boot table 16. The boot table 16 may include descriptors (e.g., firmware descriptors, software descriptors) configured to indicate a boot chain sequence according to which the processor 140 may access, read, authenticate, store, and/or execute firmware and/or software. The code images 14 may include one or more software and/or firmware components of a boot chain (e.g., a secondary boot loader (SBL), a high level operating system (HLOS) kernel, a HLOS, one or more applications, etc.). The one or more code images 14 stored in the off-chip memory 13 may correspond to one or more of a plurality of CPUs included in the processor 140. Additionally, one or more of the code images 14 may be a patch code image 15 that includes patch code for software and/or firmware stored in and/or executed by the SoC 105. The code image(s) that do not include patch code are normal images. For example, the normal image may be one or more of the SBL, the HLOS kernel, the HLOS, the one or more applications, and/or another firmware image or software image for executable code. The code image(s) 14 may include normal image(s) and/or patch code image(s) 15.

As used herein, the term code image refers to stored computer code or instructions. In some implementations, the processor 140 may execute the computer code directly from the memory device in which the code image is stored. For example, if a PBL firmware image is stored in ROM 32, the processor may read and execute the PBL firmware directly from the ROM 32 without writing the PBL firmware to a second memory device. As another example, if the SBL code image is stored in the on-chip flash memory 36 or the off-chip memory 13, the processor 140 may execute the SBL code directly from the memory 36 or 13 without copying the SBL code to a second memory device. In some implementations, the processor 140 may read the code image stored in a first memory device(s), write the code from the code image into a second memory device(s), and execute the code from the second memory device(s). For example, the processor 140 may read the SBL code image from the on-chip flash memory 36 and/or the off-chip memory 13 and write or copy the SBL code from the SBL code image into RAM 34. Subsequently, the processor 140 may execute the SBL code from RAM 34.

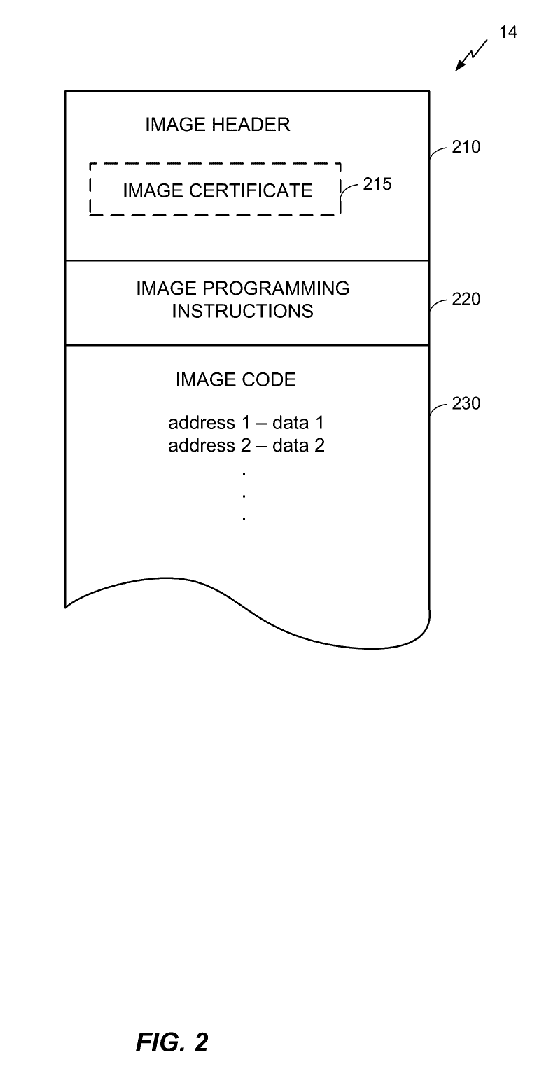

Referring to FIG. 2 with further reference to FIG. 1, a schematic diagram of a code image according to some aspects/embodiments is shown. The code image 14 includes an image header 210, an image certificate 215, image programming instructions 220, and image code 230. The code image 14 and/or the patch code image 15 may be an over-the-air (OTA) image stored post-manufacturing in the off-chip memory 13. For example, a server associated with the manufacturer of the SoC 105 may generate the OTA patch code image 15 and send the OTA patch code image 15 to the SoC 105 and/or the electronic device that includes the SoC 105. The server may send the OTA patch code image 15 over a wired or wireless communications network.

The image header 210 may include image information. The image information may include, for example, a software identification (SW_ID), image version information, an original equipment manufacturer identification (OEM_ID), a product identification, a geographic identification, and/or a market identification. The SW_ID indicates the type of software/firmware included in the code image. The SW_ID may identify the code image 14 as being the patch code image 15 or as being the normal image. For example, the SW_ID may indicate that the code image 14 is the patch code image 15 corresponding to PBL firmware stored in ROM 32. As a further example, the SW_ID may indicate that the code image 14 is an SBL image including SBL software or firmware. The image version information may indicate a version number of the code image 14. The OEM_ID, the product identification, the geographic identification, and the market identification support validation of compatibility between the code image 14 and the particular electronic device containing the SoC 105. Further, the geographic and/or market identification may indicate a particular geographic region or product market in which to utilize the particular code image 14.

In addition to the image information, the image header 210 may include the image certificate 215. The image certificate 215 is a digital certificate. For example, the image certificate 215 may conform to a X.509 standard image certificate format. The image certificate 215 may include information for use in authentication, for example, a digest of the code image 14 and a digital signature of a trusted source. The manufacturer of the SoC 105 may be the trusted source. A server associated with the trusted source may generate the digest of the code image 14 using a secure hash algorithm (SHA) or other cryptographic hash algorithm. The digest, as used herein, is a parameter obtained by performing an operation on a block of data, in which identical blocks of data produce identical digests, but any change in the block of data is likely to produce a different digest. The server may encrypt the digest using a private key to generate the digital signature. In an implementation, the server may use a dedicated private key for enhanced security controls over, for example, a patch code image 15 corresponding to PBL firmware stored in ROM. In an example, the image certificate 215 may include the SW_ID.

The image programming instructions 220 are instructions for storing the image code 230 (as described in further detail below) by the processor 140. For example, the image programming instructions 220 may be patch programming instructions for storing patch code in the OTP memory 10. The image programming instructions 220 are executable by the processor 140. In the case of the patch code image 15, the patch programming instructions may require the processor 140 to check the patch version information in order to prevent storage of patch code out of sequence. For example, if a current patch version is a fourth version of a patch and a first, second, and third version have not been provided to the SoC 105, the SoC 105 may not store the patch code and/or may generate a request for the prior patch versions. Further, if the patch version has been previously stored in the OTP memory 10, then the patch programming instructions may include instructions not to store the patch code in the OTP memory 10. The patch version information may provide a benefit of protecting against a rollback attack while reducing a number of anti-rollback fuses (not shown) designated on the SoC 105. Additionally, a benefit may be provided of avoiding potential de-synchronization between a patch version number stored in anti-rollback fuses or other configuration fuses and the contents of the patch code.

The image code 230 can be executable instructions for firmware and/or software executed by the processor 140. For the normal image, the image code 230 may be, for example but not limited to, SBL firmware or software, the HLOS kernel instructions, the HLOS instructions, application instructions, etc. For the patch code image 15, the image code 230 may be patch code. The patch code may correspond to code stored in ROM 32 (e.g., PBL firmware). The patch code may be configured to replace at least a portion of the code previously stored on the SoC. In an implementation, the previously stored program code may be the ROM code or may be software and/or firmware stored in other on-chip or off-chip memory devices of the SoC 105. For example, during execution of the PBL firmware by the processor 140, the processor 140 may replace at least a portion of the PBL firmware stored in ROM with the patch code. The patch code may include one or more address and data pairs and may provide a code update and/or alteration for security, performance, bug correction, etc. The patch code may further include embedded information such as, for example, patch type, operation type, associated values, destination address for the patch code in memory and/or registers, etc.

Referring again to FIG. 1, the on-chip components include a memory 110, a processor 140, a communications interface 160, a system reset circuit 170, and a joint test action group (JTAG) interface 180. The memory 110 (i.e., on-chip memory) can be a non-transitory, processor-readable storage medium that stores processor-readable, processor-executable software and/or firmware instructions that are configured to, when executed, cause the processor 140 to perform various functions described herein (although the description may refer only to the processor 140 performing the functions). Alternatively, the software and/or firmware may not be directly executable by the processor 140 but configured to cause the processor 140, e.g., when compiled and executed, to perform the functions. Code stored in the memory 110 includes instructions that may be part of a program, such as a particular application program and/or an operating system. The code typically includes an executing (e.g., running) program or portion of a program, current program values and state information, and the resources used by the operating system to manage the execution of the code. The memory 110 includes, but is not limited to, authentication status register (ASR) 54, one-time writable registers (OWR) 52a, 52b, 52c, OTP memory 10, content addressable memory (CAM) 20, non-volatile read-only memory (ROM) 32, random access memory (RAM) 34, and non-volatile read-write memory 36 (i.e., an on-chip flash memory, an on-chip non-volatile read-write memory, a second non-volatile read-write memory). In an embodiment, the on-chip flash memory 36 may include one or more of the code images 14 (e.g., the SBL, the HLOS, the HLOS kernel, the one or more applications, etc.) and/or the boot table 16. As used herein with regard to memory, the terms “storing,” “store,” and “stored” are equivalent, respectively, to the terms “writing,” “write,” and “written.”

The OWRs 52a, 52b, 52c and the ASR 54 are readable/writable software registers that include writable non-volatile memory (e.g., EEPROM, flash memory, ferroelectric, RAM, etc.). The quantities of the OWRs 52a, 52b, 52c and the ASR 54 shown are for simplicity but the SoC 105 may include other quantities of OWRs and ASRs than those shown in FIG. 1. Each register represents a settable binary value. The OWRs 52a, 52b, 52c (e.g., a first OWR, a second OWR, a third OWR) support an unlimited number of read operations per each power cycle of the SoC 105 but support only one write operation per each power cycle (e.g., a power cycle starts with a first system reset signal or power-on event and ends at a subsequent system reset signal or power-off event). In response to a system reset signal or power-on event, a default value may be read from the OWRs 52a, 52b, 52c. Regardless of the default value of the OWRs 52a, 52b, 52c a binary value can be written to (i.e., stored in) the OWRs 52a, 52b, 52c. However, once a value is stored in the OWRs 52a, 52b, 52c that value is unchangeable unless there is a system reset signal or power-off event. In response to the system reset signal, the value read from previously written to OWRs 52a, 52b, 52c returns to the default value.

The ASR 54 supports an unlimited number of read operations and write operations for each power cycle of the SoC 105. In response to the system reset signal or the power-on event, a default value may be read from the ASR 54. Regardless of the default value of the ASR52, a binary value can be written to (i.e., stored in) the ASR 54. The binary value may be written to the ASR52 multiple times according to particular operations of the SoC 105. In response to the system reset signal, the value read from a previously written to ASR 54 returns to the default value.

As discussed in further detail below, the OWRs 52a, 52b, 52c and/or the ASR 54 may function as write access control devices for the OTP memory 10 and/or the CAM 20. The value read from/written to each of the OWRs 52a, 52b, 52c and/or the ASR 54 may be an unlock value or a lock value. Further, the value read from/written to these registers may indicate an authentications status of the patch code image 15. For example, the unlock value may indicate an authenticated patch code image 15 and allowed write access for the OTP memory 10. The lock value may indicate an unauthenticated patch code image 15 and disallowed write access for the OTP memory 10. Additionally, the lock value may correspond to the disallowed write status for the OTP memory 10 following storage of the authenticated patch code image 15 in the OTP memory 10. In an implementation, the unlock value may be “1” and the lock value may be “0”. Alternatively, the unlock value may be “0” and the lock value may be “1”. The unlock value and lock value read from/written to the ASR 54 may or may not be equal, respectively, to the unlock value and lock value stored in the OWRs 52a, 52b, and/or 52c. In an example, the unlock value and/or the lock value read from/written to the OWRs 52a, 52b, 52c and/or the ASR 54 may be a value that is opposite from a default value of the OWRs 52a, 52b, 52c and/or the ASR 54 at power-on reset.

The OTP memory 10 (e.g., means for storing patch code) may be, for example, a programmable read-only memory (PROM) or a field PROM (FPROM). The OTP memory 10 includes fuse devices (e.g., fuses and/or anti-fuses), each of which represents a settable binary value. The OTP memory 10 is manufactured with all of the fuses in an unprogrammed state (e.g., a virgin state or a default state), such as all ones or all zeros. To write data into OTP memory 10, appropriate fuse devices are programmed (e.g., burned) from their default state to a non-default state. The processor 140 may program (i.e., write values to) the fuse devices of the OTP memory 10. Once programmed, the fuse device is no longer useful to write other data to OTP memory 10 as the fuse device may only be written to (i.e., programmed) one time. The value programmed to a particular fuse device is a permanent value of that fuse device. The fuse devices may be arranged in arrays with particular fuse devices in the arrays corresponding to particular OTP memory 10 array addresses.

The OTP memory 10 may be divided into regions according to a type of information stored in the fuse devices of a respective region. For example, the OTP memory 10 may also include a configuration region 17 that may include configuration fuses such as, for example, a patch disable fuse 18 and/or a final test fuse 19. The configuration fuses may function as write access control devices for the OTP memory 10. As described in further detail below, programmed configuration fuses 18, 19 may disable or temporarily disable read and/or write access to a respective region of the OTP memory 10 by the processor 140. Temporarily disabled means that the read and/or write access to the OTP memory 10 is disabled until the processor 140 unlocks the OTP memory 10 for read and/or write operations based on authentication of the patch code image 15. The configuration fuses 18, 19 store configuration bits. Configuration bits are permanently stored values read during the execution of program code in order to enable or disable hardware features of the SoC 105. The configuration bits are not executable code or instructions. As a further example, the fuse devices in a patch region 12 may include patch code from the patch code image 15. The patch region 12 may be a ROM patch region and the patch code may correspond to firmware, for example PBL firmware, stored in ROM 32. The patch region 12 may be further divided into one or more sub-regions corresponding to respective patch code images. For example, a first patch sub-region of the OTP memory 10 may include a first version of a patch code and a second patch sub-region of the OTP memory 10 may include a second version of the patch code. As another example, the first patch sub-region may include patch code corresponding to PBL firmware and the second patch sub-region may include patch code corresponding to other firmware and/or software (e.g., SBL code, HLOS code, applications, etc.).

Each sub-region of the patch region 12 may correspond to a respective set of read and/or write access control device(s). Each set of read and/or write access control device(s) may include the configuration fuses 18, 19 and/or the registers 52a, 52b, 52c, 54. One of each of the configuration fuses 18, 19 and the registers 42a, 52b, 52c, and 54 is shown for simplicity. However, for N sub-regions of the OTP memory, there may be N respective sets of fuses and/or registers, each set including one or more of fuses 18 and/or 19 and/or one or more of registers 52a, 52b, 52c, and/or 54.

The CAM 20 can be a semiconductor memory (e.g., static random access memory (SRAM)) and may include a patching table 22 implemented in memory hardware. The memory hardware may include registers. The patching table 22 may control implementation of patch code previously written to OTP memory 10 during execution of firmware and/or software. The processor 140 may copy address-data pairs of the patch code stored in OTP memory 10 and store the address-data pairs in the patching table 22. The patching table 22 functions as a hardware control mechanism by monitoring read access operations to the ROM 32. If a requested ROM instruction address matches one of the addresses stored in the patching table 22, then the CAM 20 re-routes the execution by the processor 140 of the code stored at the ROM 32 instruction address in order to execute code stored at the matching address in the patching table 22. At each program code address, the CAM 20 may provide an indication as to whether a patch address in the patching table 22 corresponds to the program code address in the ROM 32. In this way, the patch code stored in the patching table 22 can, for example, correct mistakes in and/or add capabilities to the firmware and/or other code previously stored in the ROM 32. In an embodiment, the patch code image 15 may include instructions that control patch implementation. These instructions may operate in lieu of or in conjunction with the CAM patching table 22.

The ROM 32 may include primary boot loader (PBL) firmware and a public key 30. The SoC manufacturer may store the PBL firmware and the public key 30 in the ROM 32 during manufacturing. Alternatively or additionally, the manufacturer may store the public key in OTP memory 10. The PBL firmware includes authentication instructions for authenticating the code images 14. The public key 30 is the root-of-trust for the post-manufacturing authentication of the patch code image 15. In an embodiment, the ROM 32 may include a plurality of public keys. Each public key may correspond to and provide the root-of-trust for a particular code image or type of code image. One or more of the public keys may be dedicated public keys that correspond to authentication for particular code images requiring higher security. For example, the patch code image 15 that includes patching code for PBL firmware stored in ROM 32 may require higher security than another code image (e.g., a code image or patch code image that corresponds to code executed at a higher level than the PBL firmware, such as applications). PBL firmware patch code may include instructions that modify fundamental operations of the processor 140, the SoC 105, and or the electronic device including the SoC 105. The dedicated public key may correspond to the dedicated private key used by the server to generate the digital signature for the higher security code image.

The processor 140 (e.g., means for determining an authentication status, means for determining an output, means for writing patch code, means for booting the SoC, means for writing a lock value, means for writing an unlock value, means for executing PBL firmware, means for replacing) is a physical processor (i.e., an integrated circuit configured to execute operations on the SoC 105 as specified by software and/or firmware, including but not limited to PBL firmware and SBL firmware or software). The processor 140 may be further configured to store one or more configuration bits in the OTP memory 10 and to update and/or otherwise modify the boot table 16. The processor 140 may be an intelligent hardware device, e.g., a central processing unit (CPU), one or more microprocessors, a controller or microcontroller, an application specific integrated circuit (ASIC), a general-purpose processor, a digital signal processor (DSP), a field programmable gate array (FPGA) or other programmable logic device, a state machine, discrete gate or transistor logic, discrete hardware components, or combinations thereof designed to perform the functions described herein and operable to carry out instructions on the SoC 105. The processor 140 may also be implemented as a combination of computing devices, e.g., a combination of DSP and a microprocessor, a plurality of microprocessors, a plurality of control processing units (CPUs), one or more microprocessors in conjunction with a DSP core, or other such configurations. The processor 140 may include co-processors including a crypto-accelerator co-processor designed to perform computationally intensive encoding decoding of information.

The processor 140 may be configured to authenticate the code images 14 during execution of PBL firmware. The code images 14 may include the patch code image 15. In other words, the PBL firmware may include authentication instructions which, when executed by the processor 140, determine an authentication status of each code image. In order to authenticate the code images 14, the processor 140 may generate a calculated digest of the patch code image using a SHA or other cryptographic hash algorithm. The SHA or other cryptographic hash algorithm used by the processor 140 is the same SHA or other cryptographic hash algorithm that was used by the server associated with the trusted source of the code image 14. The processor 140 may decrypt the digital signature using the public key 30 to generate a decrypted digest. In an example, the processor 140 may decrypt the digital signature of the patch code image 15 using the dedicated public key. The processor 140 may compare the calculated digest with the decrypted digest to determine the authentication status of the code image 14. An authentication status for the code image 14 of authenticated indicates equality between the calculated digest and the decrypted digest. The authenticated authentication status may indicate that the code image 14 and/or the patch code image 15 is unmodified since it was signed by the trusted source, and that the signer, and no one else, intentionally performed the signature operation. Conversely, inequality between the calculated digest and the decrypted digest indicates an authentication status of unauthenticated for the code image 14 and/or the patch code image 15. The unauthenticated authentication status may indicate that the signature in the code image is an untrusted signature. Further, authentication may verify the integrity of the patch code image. If the code image 14 originates from the trusted source, as indicated by the authenticated authentication status, then it is unlikely that an entity other than the trusted source has tampered with or altered the code image 14. Verification of the integrity of the code image 14 may indicate that the code image 14 has not been tampered with or altered subsequent to generation of the digest and the digital signature. Conversely, the unauthenticated code image may have been altered and/or provided to the SoC 105 by a hacker or other entity with malicious intent.

The processor 140 may also be configured to verify a validity of the code image 14 using the image information. Verifying the validity of the code image 14 may include verifying compatibility of the image information with the particular SoC 105 and/or the electronic device that includes the SoC 105. The processor 140 may verify the validity of the code image 14 based on one or more of the OEM_ID, the product identification information, the geographic identification, and the market identification information. However, validity is not necessarily indicative of the source of the code image 14 nor does validity necessarily indicate that the source of the code image 14 is a trusted source. It is possible, therefore, for the code image 14 to be authenticated but not validated or validated but unauthenticated.

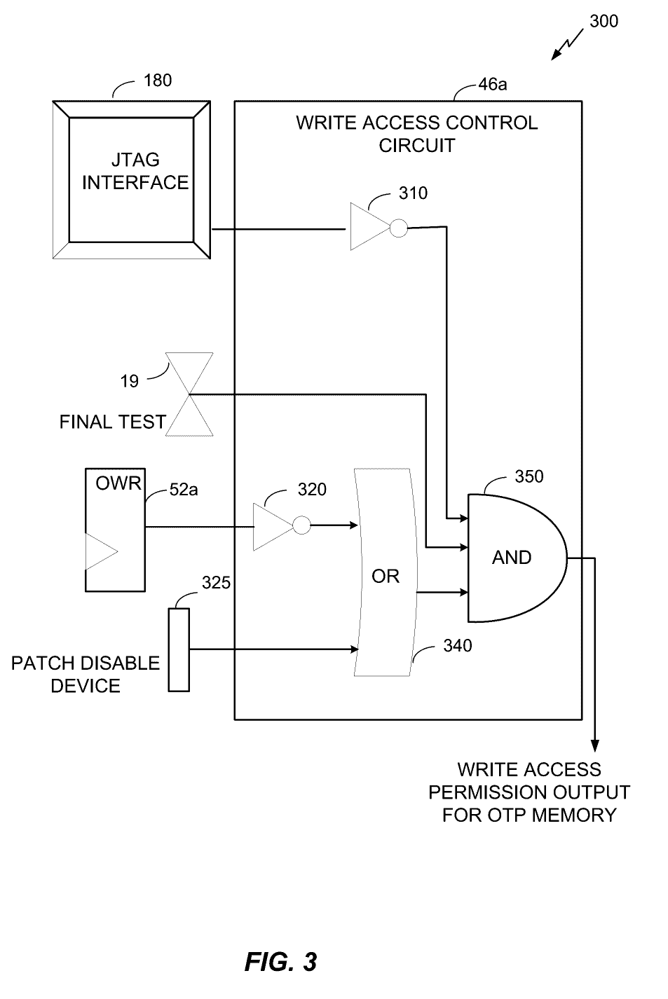

The particular values written to the registers 52a, 52b, 52c and/or 54 by the processor 140 may depend on a particular configuration of a write access control circuit 46 (e.g., means for providing an output of a write access control circuit, means for providing disabled write access, means for temporarily enabling allowed write access, means for disabling the allowed write access). The write access control circuit 46 is configured to provide one or more outputs indicative of a write access permission for the OTP memory 10 (e.g., allowed/enabled write access or disallowed/disabled write access) to the processor 140. In an embodiment, at least one of the one or more outputs of the write access control circuit 46 may indicate a write access permission for the CAM 20 (e.g., a CAM write access). The write access control circuit 46 is configured as at least a portion of SoC control logic for the registers 52a, 52b, 52c, 54, the configuration bits 18, 19, and the JTAG interface 180. As such, the write access control circuit 46 is configured to read values from the registers 52a, 52b, 52c and/or 54, the configuration bits 18, 19, and/or the JTAG interface 180. The write access control circuit includes one or more electronic logic devices. The one or more outputs of the write access control circuit may be determined logic operation of the electronic logic devices on the values read from the registers 52a, 52b, 52c and/or 54, the configuration bits 18, 19, and/or the JTAG interface 180. The output of the write access control circuit 46 may indicate the allowed write access or the disallowed write access depending on the values read from/written to the registers 52a, 52b, 52c and/or 54, the configuration bits 18, 19, and/or the JTAG interface 180. In various embodiments, the write access control circuit 46 may correspond to one of write access control circuits 46a, 46b, 46c, 46d as discussed in further detail below with regard to FIGS. 3, 5, 9, and 10. The write access to the OTP memory 10 may be a write access to the particular sub-region of the OTP memory 10 that corresponds to the particular registers and/or configuration bits read by the write access control circuit 46. The write access permission for the OTP memory may be based at least in part on the authentication status of the patch code image 15. The allowed and disallowed write access to the OTP memory 10, as determined by the write access control circuit 46, may be based on the authentication status of the patch code image 15. For example, for the authenticated patch code image 15, the control circuit 46 may indicate the allowed write access and enable write operations to the OTP memory 10. The write access to the OTP memory 10 devices may temporarily enabled. Temporarily enabled means that the write access to the OTP memory 10 may be enabled until the control circuit 46 indicates the disallowed write access. For example, values read from/written to one or more of the registers 52a, 52b, 52c and/or 54, the configuration bits 18, 19, and/or the JTAG interface 180 may change such that output of the control circuit 46 changes from being indicative of the allowed write access to being indicative of the disallowed write access. The write access control circuit 46 may provide temporarily disabled write access to at least a portion of the OTP memory 10 prior to the determination of the authentication status of the patch code image 15. The portion of the OTP memory 10 may correspond to the sub-region associated with particular registers and/or configuration bits. For temporarily disabled write access, the disallowed write access determined by the control circuit 46 may change to the allowed write access based on changes to the values read from the registers, configuration bits, and/or JTAG interface. In other words, temporarily disabled write access is disabled write access with the capability of enabled write access. Similarly, for temporarily enabled write access, the allowed write access determined by the control circuit 46 may change to the disallowed write access based on changes to the values read from the registers, configuration bits, and/or JTAG interface. In other words, temporarily enabled write access is enabled write access with the capability of disabled write access. As described in further detail below with regard to FIGS. 3-13, the write access control circuit 46 may provide temporarily disabled write access and/or temporarily enabled write access based at least in part on the operational characteristics of the registers.

For example, the processor 140 may program the configuration fuse to temporarily disable read and/or write access to the patch region 12 and/or a sub-region of the patch region 12 (e.g., the ROM patch region). Subsequently, the processor 140 may write an unlock value to one or more of the registers 52a, 52b, 52c, 54 to temporarily enable read and/or write access to the portion of the patch region 12. Writing the unlock value to the register(s) may function to override or bypass access control by the respective configuration fuse. Each respective patch sub-region of the OTP memory 10 may correspond to at least one respective dedicated register and at least one respective dedicated configuration fuse. The temporarily enabled read and/or write access may allow the processor 140 to write patch code from the authenticated patch code image 15 to the respective patch sub-region. Further, in response to storing the patch code in the patch sub-region, the processor 140 may write a lock value to one or more of the registers 52a, 52b, 52c, 54 and/or the configuration fuses to disable further access to the patch sub-region.

The communications interface 160 (e.g., means for receiving a patch code image) is configured to enable the SoC 105 to send and receive wireless signals, for example via a wireless antenna (not shown) over one or more communications networks. The communications interface 160 can include wired/wireless interfaces enabling both wired and wireless communications (including such things as a receiver, transmitter, and/or transceiver. These enable communications across and within a variety of communication networks. Examples of such communications networks include but are not limited to a wireless wide area network (WWAN), a wireless local area network (WLAN), a wireless personal area network (WPAN), and so on. The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, and so on. A CDMA network may implement one or more radio access technologies (RATs) such as cdma2000, Wideband-CDMA (W-CDMA), Time Division Synchronous Code Division Multiple Access (TD-SCDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may include an IEEE 802.11x network, and a WPAN may include a Bluetooth network, an IEEE 802.15x, for example. Wireless communication networks may include so-called next generation technologies (e.g., 4G, 5G, and so on), such as, for example, Long Term Evolution (LTE), Advanced LTE, WiMax, Ultra Mobile Broadband (UMB), and/or the like. The communications interface 160 may be further configured to communicate and exchange information, including but not limited to location information, either directly or indirectly with other communications network entities, including but not limited to, access points, base stations, navigation servers, location servers, other electronic devices, etc. The communications interface 160 may also be to receive signals from satellite vehicles (SVs) belonging to one or more Satellite Positioning Systems (SPSs), such as the GPS system, the GLONASS system, the Galileo system, and/or other SPSs.

The system reset circuit 170 (e.g., means for generating a system reset signal) is an electronic circuit configured to generate a reset signal. The system reset circuit 170 may also be referred to as a power-on reset circuit. In response to the system reset signal, the SoC 105 powers down and re-starts. At power-on reset (i.e., in response to the system reset signal), various components of the SoC 105 may be initialized to known states corresponding to a first application of voltage from the power supply 190. For example, values of the registers 52a, 52b, 52c, 54 may initialize to the default, unprogrammed value. Execution of PBL software and/or other bootloader software may commence at power-on reset. The power-on reset may also be referred to as a cold boot reset.

The joint test action group (JTAG) interface 180 is a test access port used to test functionality of the SoC 105 according to standards set by the Institute of Electrical and Electronic Engineers (IEEE). The JTAG interface 180 may be unlocked by entry of an interface password by the SoC manufacturer, for example, as part of a return material authorization (RMA). Thus, a value read from the JTAG interface 180 may indicate that the JTAG interface 180 is password locked or password unlocked. In the password locked state, values stored in components of the SoC 105 and/or other functionality of the SoC 105 may not be modified via the JTAG interface 180. In the password locked state, values stored in components of the SoC 105 and/or other functionality of the SoC 105 may be modified via the JTAG interface 180.

Referring to FIG. 3 with further reference to FIGS. 1 and 2, a symbolic logic representation of an example of a write access control system for an OTP memory according to some aspects/embodiments is shown. A write access control system 300 includes the write access control circuit 46a. The specific Boolean operations of the write access control circuit 46a are examples only and not limiting. The write access control circuit 46a includes a first NOT gate 310, a second NOT gate 320, an OR gate 340, and an AND gate 350. As used herein, “NOT,” “OR,” and “AND” refer to Boolean functions and “gate” refers to an electronic logic gate. The system 300 operates on values read from the JTAG interface 180, the final test configuration fuse 19, a patch disable device 325, and the OWR 52a. The patch disable device 325 may be, for example, the patch disable configuration fuse 18 or the OWR 52b. In the control circuit 46a, the output of the AND gate 350 is the write access permission output for the OTP memory 10. The write access to the OTP memory 10 determined by the control circuit 46a may be the write access for the particular patch sub-region that corresponds to the patch disable device 325, the configuration fuse 19, and the OWR 52a.

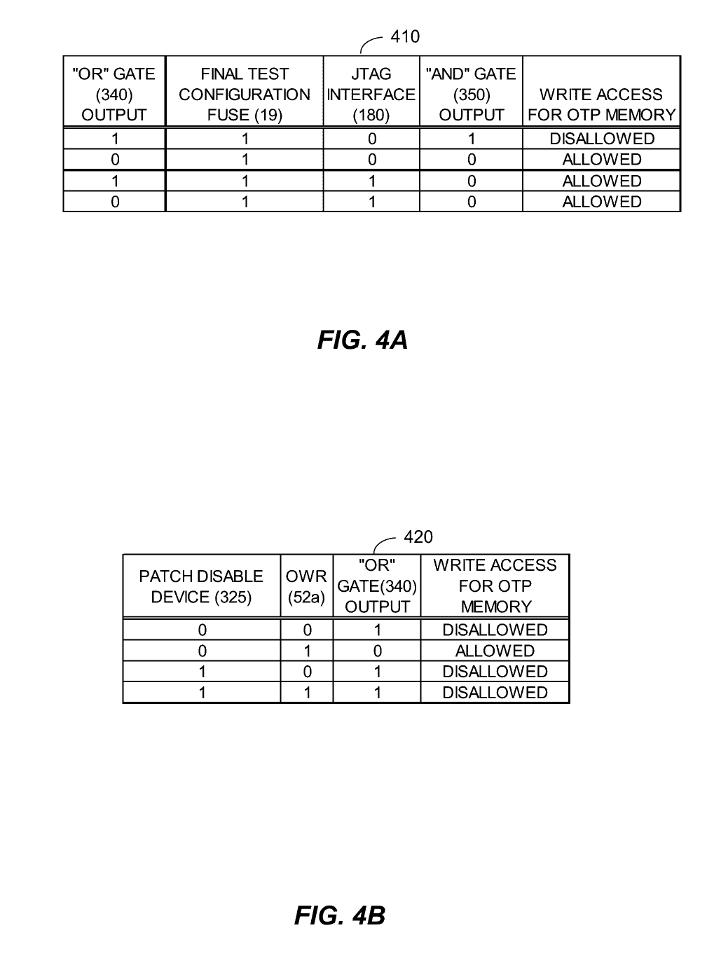

Referring to FIGS. 4A and 4B with further reference to FIGS. 1-3, examples of truth tables for the logic functions of the write access control system in FIG. 3 according to some aspects/embodiments are shown. The specific binary values of these truth tables are examples only and not limiting. The SoC manufacturer may directly program ROM patch code into the OTP memory 10. At final test or another stage of SoC manufacturing the SoC manufacturer may directly program patch code into the OTP memory 10 without assistance from the processor 140 or modules thereof. Subsequently, and prior to shipping, the SoC manufacturer may program the final test fuse 19 and/or password lock the JTAG interface 180.

At power-on reset (or initial power on) post-manufacturing, the write access control circuit 46a may read a programmed value from the final test configuration fuse 19 and a password locked value from the JTAG interface 180. For example, the programmed value of the final test fuse 19 may be “1” and the password locked value from the JTAG interface 180 may be “0”. As indicated in truth table 410, with these values read from the final test fuse 19 and the JTAG interface 180, if the OR gate 340 output is “1”, the write access is disallowed and if the OR gate 340 output is “0”, the write access is allowed. Thus, the write access for the OTP memory 10 depends on the output of the OR gate 340. The OR gate 340 output depends on the values read from the patch disable device 325 and the OWR 52a. As shown in the truth table 420, regardless of the value of the patch disable device 325, if the value read from the OWR 52a is “0”, then the OR gate 340 output is “1”. The “0” value of the OWR 52a may correspond to the default value of the OWR 52a at power-on reset. Referring back to the first row of the truth table 410, with the OR gate 340 output of “1”, if the SoC 105 is shipped by the SoC manufacturer with a password locked JTAG interface (e.g., “0”) and the final test fuse 19 programmed (e.g., “1”), then the write access at power-on reset for the OTP memory 10 is disallowed by default. Therefore, in this example, the “0” value of the OWR 52a is a lock value. The lock value read from the OWR 52a corresponds to the disallowed write access to the OTP memory 10. This disallowed write access to the OTP memory 10 may correspond to the temporarily disabled write access. Referring to the second rows of truth tables 410 and 420, if the patch disable device 325 is unprogrammed (e.g., “0”) and a value of “1” is written to and read from the OWR 52a, then the write access permission for the OTP memory 10 is the allowed write access. Therefore, in this example, the “1” value of the OWR 52a is an unlock value. The unlock value read from the OWR 52a corresponds to the allowed write access to the OTP memory 10. Thus, although the write access to the OTP memory may be disabled by default at power-on reset, the value written to and read from the OWR 52a may change the disallowed write access to the allowed write access. In the above manner, the OWR 52a may provide the capability of write access being allowed and controlled post-manufacturing.

Referring to the third and fourth rows of truth table 420 and the first row of 410, if the patch disable device 325 is programmed (e.g., “1”), then the write access permission is the disallowed write access. Further, the password unlocked JTAG interface 180 (e.g., “1”) can enable write access regardless of the values of the fuse 19, the device 325, and the OWR 52a. Since the SoC manufacturer controls access to the JTAG interface password, the capability of the JTAG interface to allow write access to the OTP memory 10 may not diminish the security control of the SoC provided by the system 300.

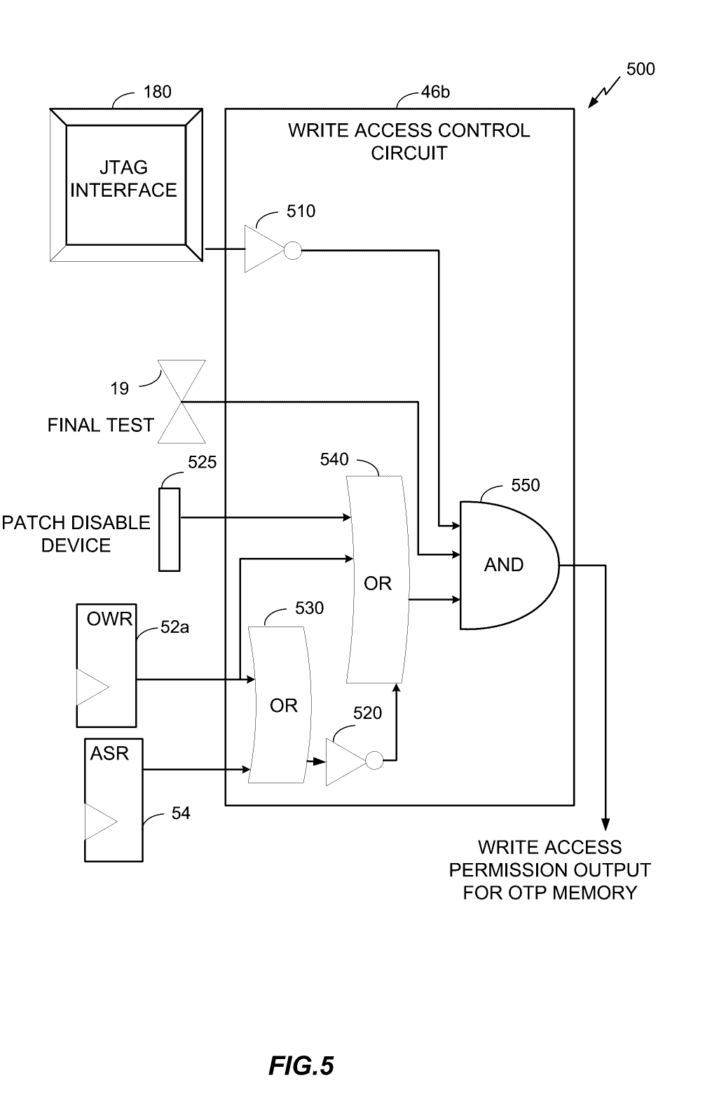

Referring to FIG. 5 with further reference to FIGS. 1 and 2, a symbolic logic representation of an example of a write access control system for an OTP memory according to some aspects/embodiments is shown. A write access control system 500 includes the write access control circuit 46b. The specific Boolean operations of the write access control circuit 46b are examples only and not limiting. The write access control circuit 46b of the system 500 includes a first NOT gate 510, a second NOT gate 520, a first OR gate 530, a second OR gate 540, and an AND gate 550. The system 500 operates on values read from the JTAG interface 180, the final test configuration fuse 19, a patch disable device 525, the OWR 52a, and the ASR 54. The patch disable device 525 may be, for example, the patch disable configuration fuse 18 or the OWR 52b. In the control circuit 46b, the output of the AND gate 550 is the write access permission output for the OTP memory 10. The write access to the OTP memory 10 determined by the control circuit 46b may be the write access for the particular patch sub-region that corresponds to the patch disable device 525, the configuration fuse 19, and the OWR 52a.

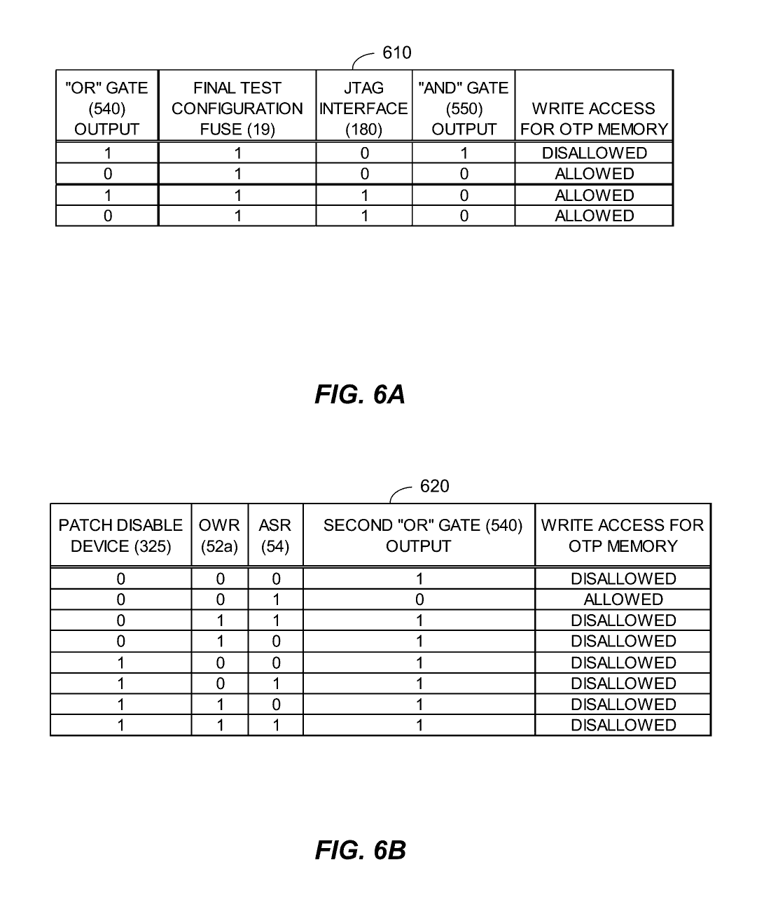

Referring to FIGS. 6A and 6B with further reference to FIGS. 1, 2, and 5, examples of truth tables for the logic functions of the write access control system in FIG. 5 according to some aspects/embodiments are shown. The specific binary values of these truth tables are examples only and not limiting. As similarly discussed above, at final test and/or prior to shipping of the SoC 105 by the manufacturer, the manufacturer may program the final test configuration fuse 19 and/or password lock the JTAG interface 180.

At power-on reset (or initial power on) post manufacturing, the write access control circuit 46b may read a programmed value from the final test configuration fuse 19 and a password locked value from the JTAG interface 180. For example, the programmed value of the final test fuse 19 may be “1” and the password locked value from the JTAG interface 180 may be “0”. As indicated in truth table 610, with these values read from the final test fuse 19 and the JTAG interface 180, if the OR gate 540 output is “1”, the write access is disallowed and if the OR gate 340 output is “0”, the write access is allowed. Thus, the write access for the OTP memory 10 depends on the output of the OR gate 540.

The OR gate 540 output depends on the values read from the patch disable device 525, the OWR 52a, and the ASR 54. As shown in truth table 620, regardless of the value of the patch disable device 525, if the values read from the OWR 52a and the ASR 54 are both “0”, then the OR gate 540 output is “1”. The “0” value of the OWR 52a and of the ASR 54 may correspond to the default value of these registers at power-on reset. Referring back to the first row of the truth table 610, with the OR gate 540 output of “1”, if the SoC 105 is shipped by the SoC manufacturer with the password locked JTAG interface 180 (e.g., “0”) and the final test fuse 19 programmed (e.g., 1), then the write access at power-on reset for the OTP memory 10 may be disallowed by default. This disallowed write access to the OTP memory 10 may correspond to the temporarily disabled write access. Referring to the second rows of truth tables 610 and 620, if the patch disable device 525 is unprogrammed (e.g., “0”), a value of “0” is read from the OWR 52a, and a value of “1” is read from the ASR 54, then the write access permission status for the OTP memory 10 is the allowed write access. Therefore, in this example, the “1” value of the ASR 54 is the unlock value for the ASR 54. The unlock value read from the ASR 54 corresponds to the allowed write access to the OTP memory 10. Thus, although the write access to the OTP memory may be disabled by default at power-on reset, the value written to and read from the ASR 54 may change the disallowed write access to the allowed write access. Additionally, referring to the first row of truth table 610 and the third and fourth rows of truth table 620, if the patch disable device 525 is unprogrammed (e.g., “0”) and a value of “1” is read from the OWR 52a, and then the write access permission is the disallowed write access for the OTP memory 10. Therefore, in this example, the “1” value of the OWR 52a is the lock value for the OWR 52a. Thus, although the write access to the OTP memory may be disabled by default at power-on reset, the value written to and read from the ASR 54 may change the disallowed write access to the allowed write access. In the above manner, the OWR 52a and the ASR 54 provide the capability of write access being allowed and controlled post-manufacturing. Similarly to the system 300, and referring to the third and fourth rows of truth table 610, the password unlocked JTAG interface 180 can enable write access regardless of the values of the fuse 19, the device 525, the OWR 52a, and the ASR 54.

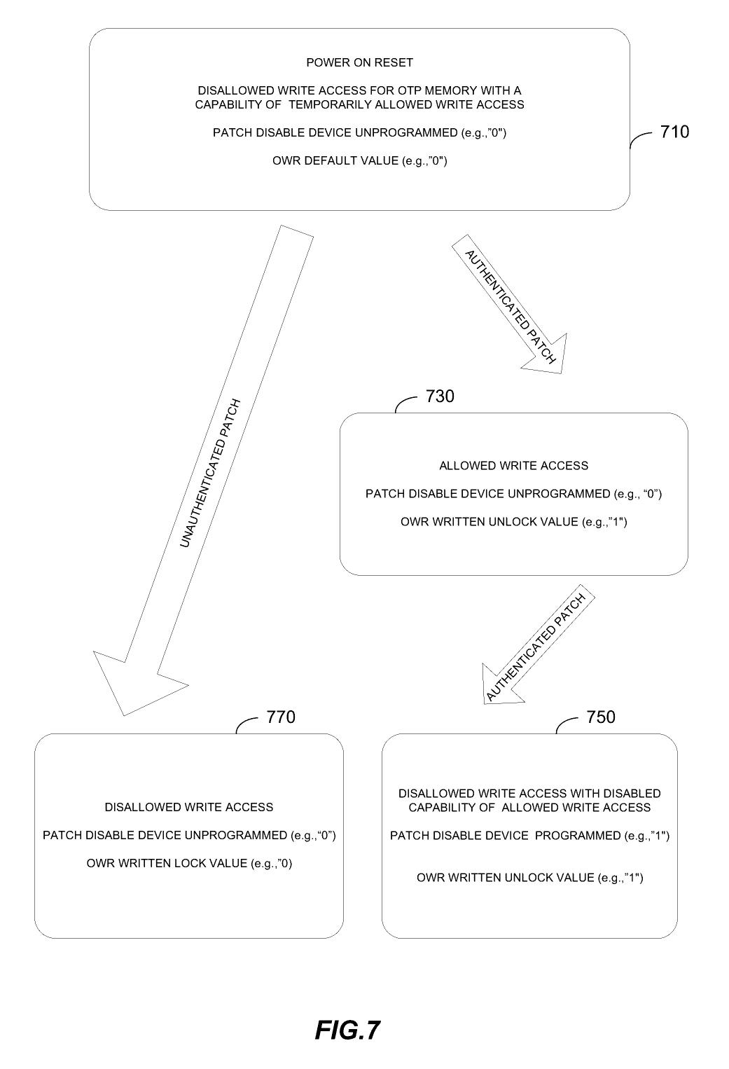

Referring to FIG. 7, with further reference to FIGS. 1-4B, a state transition diagram based on the write access control system of FIG. 3 according to some aspects/embodiments is shown. A state 710 may occur at an initial power-on and/or the power-on reset. The state 710 corresponds to disallowed write access for the OTP memory 10 with a capability of temporarily allowed write access. In this state, the patch disable device 325 may be unprogrammed. Further, the value read from the OWR 52a by the write access control circuit 46a may be a default value at power-on reset. As discussed above with regard to FIGS. 3, 4A, and 4B, the capability of the allowed write access is based on the ability of the write access control system 300 to override the default disallowed write access based on the value of the OWR 52a.

A state 730 may occur in response to a determination by the processor 140 of the authentication status of the patch code image 15 as being authenticated. For the authenticated patch code image 15, the state 730 corresponds to the allowed write access for the OTP memory 10. In this state, the patch disable device 325 may be unprogrammed. Further, the value read from the OWR 52a by the write access control circuit 46a may be a written unlock value. For example, the processor 140 may write the unlock value to the OWR 52a. This allowed write access state may be a temporarily allowed write access state (e.g., corresponding to a temporarily unlocked state of the OTP memory 10) because the processor 140 may subsequently change the value of one or more of the write access control devices to lock or re-lock the OTP memory 10.

A state 750 may occur in response to storage of the patch code in the patch region 12 of the OTP memory 10. The state 750 corresponds to a disallowed write access with disabled capability of allowed write access for the OTP memory 10. In this state, the patch disable device 325 is programmed. For example, the processor 140 may program the patch disable fuse 18 in response to the storage of the patch code in the patch region 12. The value of the OWR 52a at the state 750 may still be the written unlock value because the OWR 52a may only be written to once during a power cycle. Referring back to the truth table 420, once the patch disable device 325 is programmed, the write access to the OTP memory 10 is disallowed regardless of the value of the OWR 52a. In this way, the stored patch code may only be altered through the JTAG interface 180 (for example, as part of a RMA). As discussed above, due to the capability of the value written to the OWR 52a to disable write access, the allowed write access of stage 730 is a temporary allowed write access.

A state 770 may occur in response to a determination by the processor 140 of the unauthenticated authentication status of the patch code. The state 770 corresponds to a disallowed write access for the OTP memory 10. In this state, the patch disable device 325 may be unprogrammed. Further, the value read from the OWR 52a by the write access control circuit 46a may be a written lock value. For example, the processor 140 may write the lock value to the OWR 52a. The written lock value for the OWR 52a disables the capability of temporary allowed write access. Due to the capability of the value written to the OWR 52a to disable write access, the capability for temporarily allowed write access that existed at the stage 710 may be disabled at the stage 770.

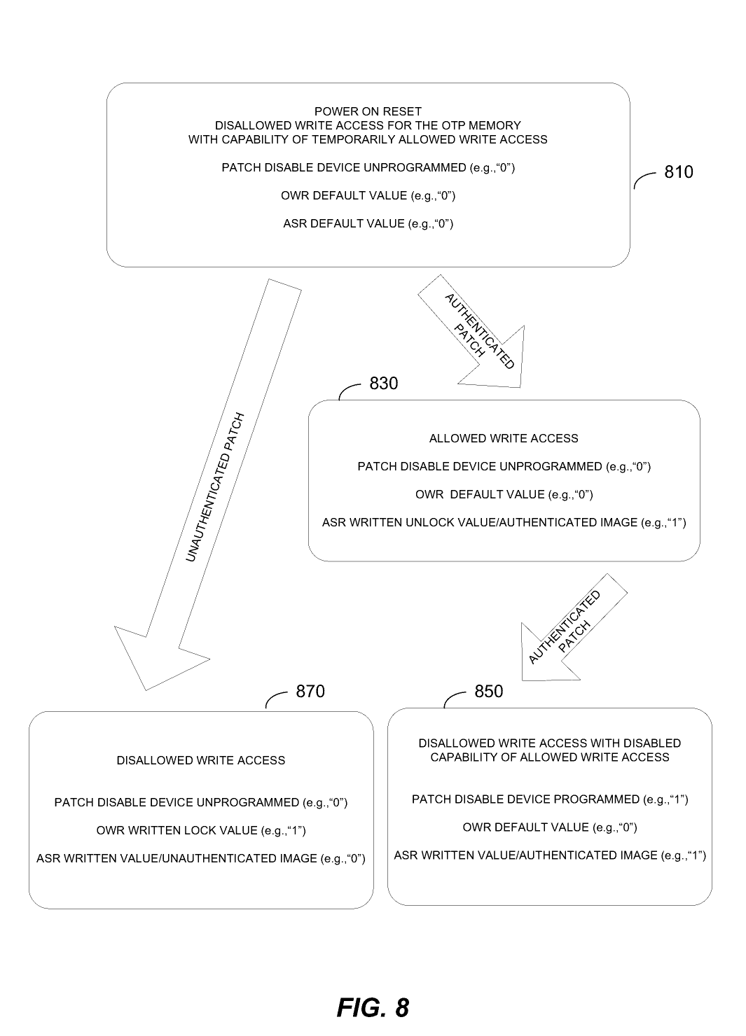

Referring to FIG. 8, with further reference to FIGS. 1, 2, 5, 6A, and 6B, a state transition diagram based on the write access control system of FIG. 5 according to some aspects/embodiments is shown. A state 810 may occur at the initial power-on or the power-on reset. The state 810 corresponds to disallowed write access for the OTP memory 10 with a capability of temporarily allowed write access. In this state, the patch disable device 325 may be unprogrammed. Further, the values read from OWR 52a and ASR 54 by the write access control circuit 46b may be the default values. As discussed above with regard to FIGS. 5, 6A and 6B, the capability of the allowed write access is based on the ability of the write access control system 500 to override the default disallowed write access based on the value of the ASR 54 and reinstate the disallowed write access based on the value of the OWR 52a.

A state 830 may occur in response to a determination by the processor 140 of the authentication status of the patch code image 15 as being authenticated. For the authenticated patch code image 15, the state 830 corresponds to the allowed write access for the OTP memory 10. In this state, the patch disable device 525 may be unprogrammed and the value read from the OWR 52a by the write access control circuit 46b may the default value. Further, the value read from the ASR 54 by the write access control circuit 46b may be a written unlock value. For example, the processor 140 may write the unlock value to the ASR 54. This allowed write access state may be a temporarily allowed write access state (e.g., corresponding to a temporarily unlocked state of the OTP memory 10) because the processor 140 may subsequently change the value of one or more of the write access control devices to lock or re-lock the OTP memory 10).

A state 850 may occur in response to storage of the patch code in the patch region 12 of the OTP memory 10. The state 850 corresponds to a disallowed write access with disabled capability of allowed write access for the OTP memory 10. In this state, the patch disable device 525 may be programmed. For example, the processor 140 may program the patch disable fuse 18 and/or may write a lock value to the OWR 52b in response to the storage of the patch code in the patch region 12. Additionally, the processor 140 may write a lock value to the OWR 52a (e.g., a written lock value). The value of the ASR 54 may be the written lock value from the stage 830, however, the value of the ASR 54 can change during a power cycle. Referring to the truth table 620, once the patch disable device 525 is programmed, the write access to the OTP memory 10 is disallowed. In this way, the stored patch code may only be altered through the JTAG interface 180 (for example, as part of a RMA). Due to the capability of the value written to patch disable device 525 to disable write access, the allowed write access of stage 830 is a temporarily allowed write access.

A state 870 may occur in response to a determination by the processor 140 of the authentication status of the patch code image 15 as unauthenticated. The state 870 corresponds to a disallowed write access for the OTP memory 10. In this state, the patch disable device 525 may be unprogrammed. Further, the value read from the OWR 52a by the write access control circuit 46b may be a written lock value. For example, the processor 140 may write the lock value to the OWR 52a. Due to the capability of the value written to the OWR 52a to disable write access, the capability for temporarily allowed write access that existed at the stage 810 may be disabled at the stage 870. As the ASR 54 value is changeable within a power cycle, writing the lock value to the OWR 52a locks the OTP memory 10 regardless of the value stored in or read from the ASR 54.

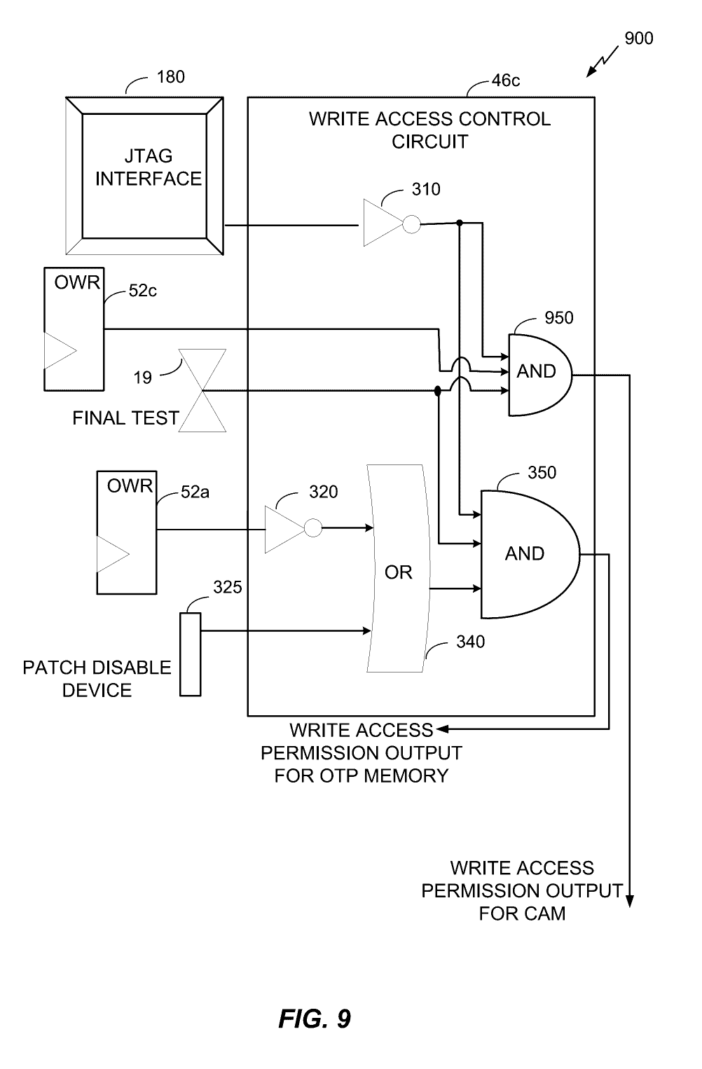

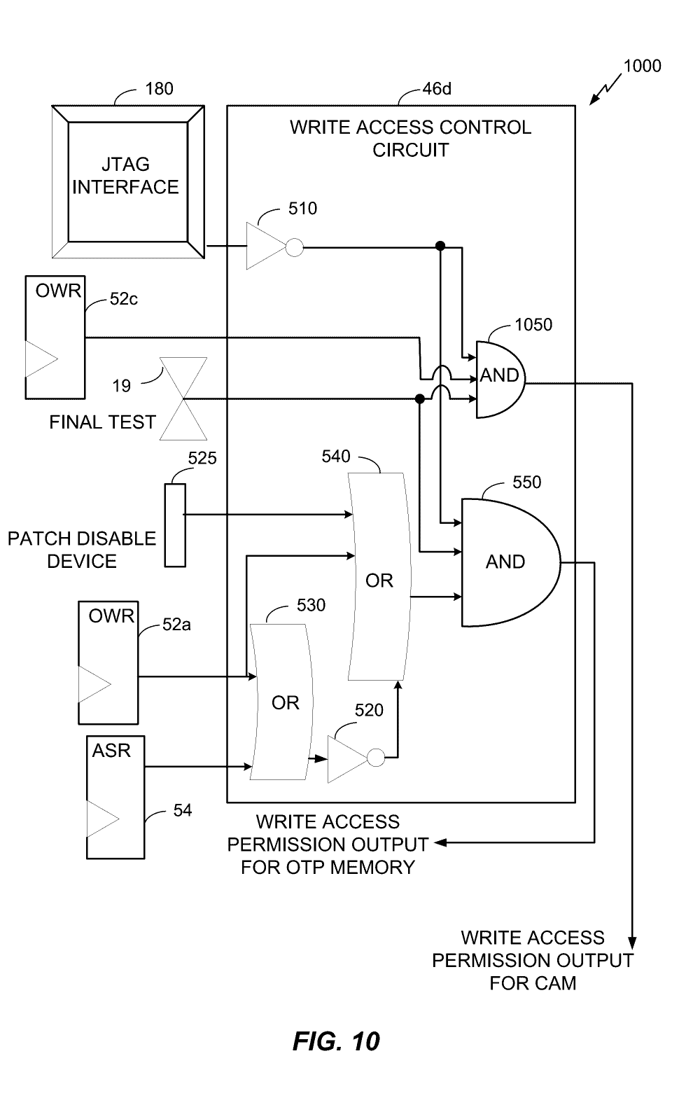

Referring to FIGS. 9 and 10 with further reference to FIGS. 1-8, symbolic logic representations of examples of write access control systems for a CAM according to some aspects/embodiments are shown. The write access control system 900 in FIG. 9 includes the write access control circuit 46c. The write access control system 1000 in FIG. 10 includes the write access control circuit 46d. The specific Boolean operations of the write access control circuits 46c and 46d are examples only. The system 900 includes the system 300, as discussed above with regard to FIG. 3, and further includes a second AND gate 950. In this example, the AND gate 350 is a first AND gate. The second AND gate 950 operates on the values read from the JTAG interface 180, the final test configuration fuse 19, and the OWR 52c. The output of the AND gate 350 is a write access permission output for the OTP memory 10 (e.g., a first output of the write access control circuit 46c) and the output of the AND gate 950 output is a write access permission output for the CAM 20 (e.g., a second output of the write access control circuit 46c). The write access control system 1000 includes the system 500, as discussed above with regard to FIG. 5, and further includes a second AND gate 1050. In this example, the AND gate 550 is a first AND gate. The second AND gate 1050 operates on the values read from the JTAG interface 180, the final test configuration fuse 19, and the OWR 52c. The output of the AND gate 550 is a write access permission output for the OTP memory 10 (e.g., a first output of the write access control circuit 46d). The output of the AND gate 1050 is a write access permission output for the CAM 20 (e.g., a second output of the write access control circuit 46d).

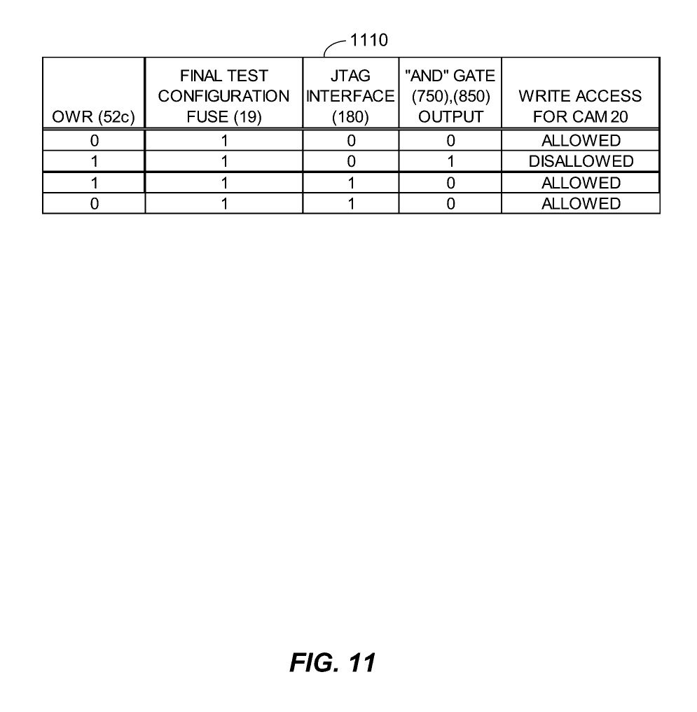

Referring to FIG. 11 with further reference to FIGS. 9 and 10, an example of a truth table for the logic functions of the AND gates shown in FIGS. 9 and 10 according to some aspects/embodiments is shown. The specific binary values of a truth table 1100 are examples only and not limiting. An output of “0” from either the AND gate 950 or the AND gate 1050 corresponds to the allowed write access for the patching table 22 of the CAM 20. An output of “1” from either the AND gate 950 or the AND gate 1050 corresponds to the disallowed write access for the CAM 20. For the control circuits 46c and 46d, the CAM unlock value of the OWR 52c is “0”, a programmed final test configuration fuse corresponds to a “1”, a password unlocked JTAG interface 180 corresponds to a “1”, a password locked JTAG interface 180 corresponds to a “0”. The default value of the OWR 54c at power-on-reset may correspond to the unlock value.

Referring to the first row of the truth table 1110, the value “0” read from the OWR 52c combined with the programmed final test configuration fuse 19 (e.g., “1”) and the password locked JTAG interface 180 (e.g., “0”) yields an output from the AND gate 950 and the AND gate 1050 of “0” corresponding to the allowed write access for the patching table 22. Referring to the second row of the truth table 1110, a value of “1” read from the OWR 52c combined with the programmed final test configuration fuse 19 and the password locked JTAG interface 180 yields an output from the AND gate 950 and the AND gate 1050 of “1” corresponding to the disallowed write access for the patching table 22. Therefore, for the write access control circuits 46c and 46d, the value stored in and read from the OWR 52c controls the write access to the patching table 22. Additionally, referring to the third and fourth rows of the truth table 1110, the JTAG interface 180 can enable write access to the CAM 20 regardless of the values of the patch disable device 525 and the OWR 52c.

If the SoC 105 is shipped by the SoC manufacturer with the password locked JTAG interface 180 and the final test fuse 19 programmed, then the write access to the CAM 20 at power-on reset of the SoC 105 may be allowed in response to the system reset signal. Execution of the PBL firmware may commence at power-on reset. During execution of the PBL firmware, the processor 140 may copy address-data pairs from the patch code previously stored in the OTP memory 10 to the registers in the CAM patching table 22 in order for the processor 140 to execute patched PBL firmware. However, once the patch code is copied into the CAM 20, disabling write access to the CAM 20 may prevent subsequent alteration of the CAM 20. This may prevent malicious and/or unauthorized code from attacking or altering operations under direction of the patching table 22. The OWR 52c provides the capability of the CAM 20 being temporarily unlocked post-manufacturing.

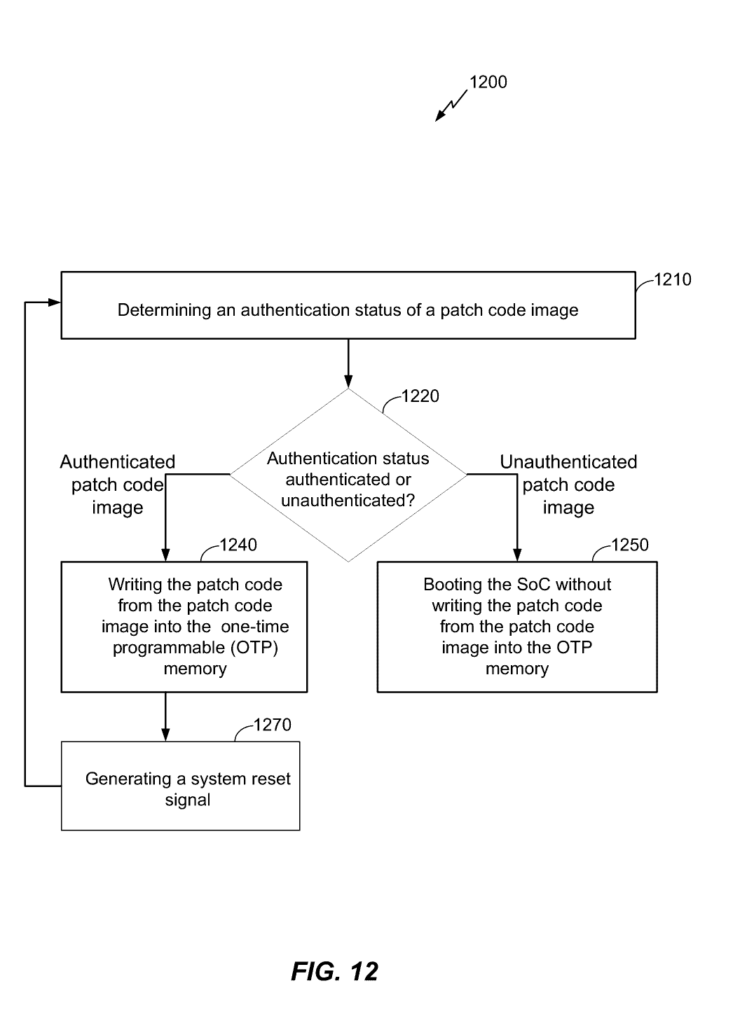

Referring to FIG. 12 with further reference to FIGS. 1-11, a method of securely writing patch code to an OTP memory of the SoC according to some aspects/embodiments is shown. In an implementation, writing patch code to the OTP memory of the SoC may include updating previously written patch code stored in the OTP memory. A method 1200 is an example only and not limiting. The method 1200 can be altered, e.g., by having stages added, removed, rearranged, combined, and/or performed concurrently.

At stage 1210, the method 1200 includes determining an authentication status of a patch code image comprising patch code. The processor 140 may determine the authentication status based on the digital signature and the public key 30. For example, during execution of the PBL firmware, the processor 140 may read header information in the one or more code images 14. The code images 14 may include normal image(s) and/or patch code image(s) 15. Determining the authentication status of the patch code image 15 may include verifying that a particular code image 14 is the patch code image 15 and/or verifying the source of the patch code image 15. Based at least in part on the SW_ID in the image header, the processor 140 may determine if the particular code image 14 is the patch code image 15 or the normal image. The processor 140 may verify the source of the particular code image based at least in part on the digital signature and on the public key 30. If the particular code image is the patch code image 15, then the processor 140 may verify the source of the patch code image 15 based at least in part on the digital signature and on the public key 30. In an implementation, the processor 140 may verify the source of the patch code image 15 using the dedicated public key. In this way, the processor 140 may verify that the source of the patch code image 15 is the trusted source. As discussed in more detail above, the authentication status for the patch code image 15 of authenticated indicates equality between the calculated digest and the decrypted digest. Conversely, inequality between the calculated digest and the decrypted digest indicates an authentication status of the patch code image 15 of unauthenticated. Similarly, the calculated digest and the decrypted digest for one or more normal images may indicate the authentication status of the one or more normal images. In an implementation, the processor 140 may determine the authentication status of a plurality of code images 14, the plurality of code images including zero or more patch code images 15 and one or more normal images.

In an embodiment, the stage 1210 may further include receiving the code images 14 post-manufacturing via a signal received at the SoC. For example, a server may provide the patch code image 15 to the SoC 105 and/or to an electronic device that includes the SoC 105. The SoC 105 may receive the patch code image 15 via wired and/or wireless signals. For example, the patch code image 15 may be an over-the-air (OTA) image and the communications interface 160 may receive the patch code image 15 via the wireless signals. In response to receiving the patch code image 15, the processor 140 may store the patch code image 15 in the off-chip memory 13 and/or the on-chip flash memory 36 prior to determining the authentication status. However, prior to determining the authentication status, these stored images are not executable by the processor 140. Firmware descriptors in the boot table 16, the CAM 20, and/or other mechanisms or pointers that direct the processor 140 to execute code from a particular memory location are only set to direct the processor 140 to memory locations including authenticated images and/or code copied from authenticated images.

At stage 1220, the method 1200 branches to stage 1240 or stage 1250 based on the authentication status of the code image. If the authentication status determined at the stage 1210 indicates the authenticated patch code image 15, then the method 1200 continues to the stage 1240. If the authentication status determined at the stage 1210 indicates the unauthenticated patch code image, then the method 1200 continues to the stage 1250. If the authentication status determined at the stage 1210 indicates the authenticated normal image (e.g., none of the code images 14 are the patch code image 15), the method 1200 may also branch to the stage 1250. If the authentication status determined at the stage 1210 indicates the unauthenticated normal image (e.g., none of the code images 14 are authenticated and none of the code images 14 are the patch code image 15) then the processor 140 may terminate operations of the SoC 105 and/or may instruct the system reset circuit 170 to generate the system reset signal. Alternatively, if a first normal image is unauthenticated, the processor 140 may change a firmware descriptor in the boot table 16 in order to repeat the authentication process for a second and different normal image.

At stage 1240, the method 1200 includes storing the patch code from the patch code image in the OTP memory. For example, the processor 140 may store the patch code in the fuse devices of the OTP memory. Current and/or voltage provided to the OTP memory 10 under the direction of the processor 140 may be indicative of programming of OTP memory 10 devices. In an implementation, the processor 140 may store the patch code according to image programming instructions 220. Further, the processor 140 may store the image information from the image header 210 in the configuration bits. In response to storing the patch code in the OTP memory 10, the processor 140 may update and/or otherwise modify the boot table 16 and remove the firmware descriptor for the patch code image 15. In this way, the patch code image 15 may no longer be accessible by the processor 140. In an embodiment, the stage 1240 may further include removing the patch code image 15 from the off-chip memory 13 subsequent to storing the patch code in the OTP memory 10. For example, the processor 140 may erase the patch code image 15 once the patch code has been copied to the OTP memory 10. In an implementation, the stage 1240 may further include flashing normal images. For example, the processor 140 may authenticate the one or more normal images at the stage 1210 and may store the authenticated normal image(s). The normal image(s) may include new and/or updated software and/or firmware.

At stage 1270, the method 1200 includes rebooting the SoC 105. For example, the system reset circuit 170 may generate the system reset signal. In response to the system reset signal, the method 1200 may return to the stage 1210. Execution of the PBL firmware may commence at power-on reset. During execution of the PBL firmware, the processor 140 may copy address-data pairs from the patch code previously stored in the OTP memory 10 to the registers in the CAM patching table 22. The processor 140 may execute the patched PBL firmware. For example, the processor 140 may execute one or more patch code instructions stored in the CAM 20 in lieu of one or more PBL firmware instructions stored in the ROM 32. Additionally, the registers 52a, 52b, 52c, and 54 may initialize to default values in response to the system reset signal.

At stage 1250, the method 1200 includes booting the SoC without storing the patch code from the patch code image in the OTP memory. Stage 1250 occurs if the patch code image 15 is unauthenticated or if the patch code image is non-existent and the code image(s) 14 is the authenticated normal image. In the case of the unauthenticated patch code image, the patch code from the unauthenticated patch code image is not stored in the patch region 12. As a result, the code from the unauthenticated patch code image is not available for execution by the SoC 105. This may protect the SoC 105 from executing malicious and/or unauthorized code in the unauthenticated patch code image. In the case of one or more authenticated normal images, the processor 140 may replace a previously stored normal image with one or more of the authenticated normal images. For example, the normal images may include updated versions of software and/or firmware. The processor may execute the one or more normal images which may include execution of the SBL instructions and/or other firmware or software in the boot chain sequence in order to boot the SoC 105. During this execution, the SoC 105 may receive new code images 14. The processor 140 may instruct the system reset circuit to generate a system reset signal and return to the stage 1210 to authenticate the new code images 14. In an embodiment, the stage 1250 optionally includes programming anti-rollback fuses (not shown).

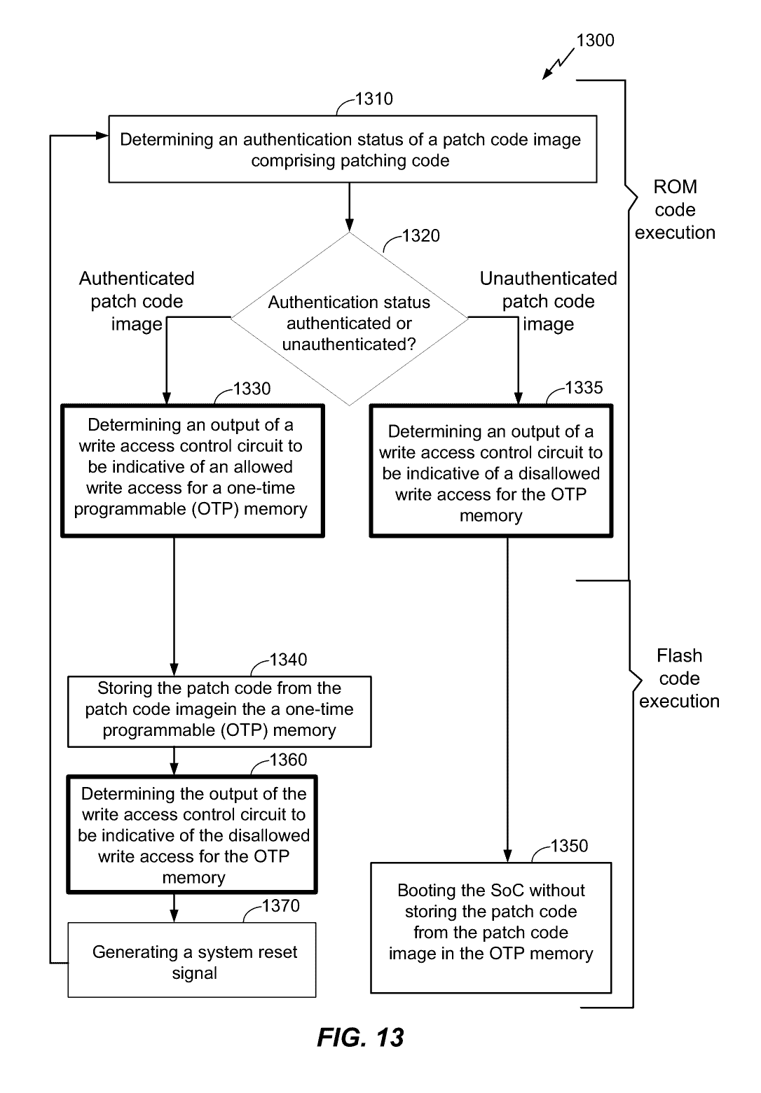

Referring to FIG. 13 with further reference to FIGS. 1-12, a method of securely writing patch code to the OTP memory of the SoC according to some aspects/embodiments is shown. In an implementation, writing patch code to the OTP memory of the SoC may include updating previously written patch code stored in the OTP memory. A method 1300 is an example only and not limiting. The method 1300 can be altered, e.g., by having stages added, removed, rearranged, combined, and/or performed concurrently. Stages 1310, 1320, 1340, 1350, and 1370 of the method 1300 are similar in some respects as described above for stages 1210, 1220, 1240, 1250, and 1270 of the method 1200.

At stage 1310, the method 1300 includes determining an authentication status of a patch code image comprising patch code. For example, the processor 140 may determine the authentication of one or more code images 14 during ROM code execution (e.g., during execution of PBL firmware stored in ROM 32). The one or more code images 14 may include normal image(s) and/or patch code image(s) 15. Prior to the stage 1310 (e.g., after power-on reset and prior to determining the authentication status of the code images), the method 1300 may include determining the output of the write access control circuit 46a, 46b, 46c, or 46d to be indicative of the disallowed write access for the OTP memory 10. The write access control circuit 46a, 46b, 46c, or 46d may provide the output based at least in part on the values read from the write access control devices. The processor 140 may determine the provided output to be indicative of the disallowed write access. As discussed above with regard to FIGS. 3-11, in this state, the write access is disallowed with the capability of temporarily allowed write access based on the values read from the write access control devices. Additionally, prior to the stage 1310, the method 1300 may include determining an output of the write access control circuit 46c, 46d to be indicative of an allowed write access for the CAM 10. The write access control circuit 46c, or 46d may provide the output based at least in part on the values read from the write access control devices. The processor 140 may determine the provided output to be indicative of the allowed write access. The allowed write access at power-on reset may enable the processor 140 to modify the patching table 22 during execution of PBL firmware. The processor 140 may modify the patching table 22 in order to enable execution of patch code previously written to the OTP memory 10 prior to the power-on reset.

At stage 1320, the method 1300 branches to stage 1330 or 1335 based on the authentication status of the code image. If the authentication status determined at the stage 1310 indicates the authenticated patch code image 15, then the method 1300 continues to the stage 1330. If the authentication status determined at the stage 1310 indicates the unauthenticated patch code image, then the method 1300 continues to the stage 1335. If the authentication status determined at the stage 1310 indicates the authenticated normal image, the method 1300 may also branch to the stage 1335.

At stage 1330, the method 1300 includes determining an output of a write access control circuit to be indicative of an allowed write access for an OTP memory 10. The processor 140 may write unlock values to one or more write access control devices OWR 52a or ASR 54 based on the authentication status of the patch code image 15. The unlock values written to the one or more of the write access control devices may determine the output of the write access control circuit 46. The write access control circuit 46 may provide the output based at least in part on the values read from the write access control devices. The processor 140 may determine the provided output to be indicative of the allowed write access. The processor 140 may perform these operations during ROM code execution.

In an embodiment, with reference to FIGS. 3 and 9, based on the authenticated authentication status being determined at the stage 1310, at the stage 1330 the processor 140 may write an unlock value (e.g., an OWR unlock value) to the OWR 52a. The unlock value may be a value that is opposite from the default value of the OWR 52a set in response to the system reset signal. For example, if the default value of the OWR 52a is “0”, then the processor 140 may write the unlock value of “1” into the OWR 52a. The write access control circuit 46a or 46c may read the unlock value of the OWR 52a and may generate the write access control circuit output indicating the allowed write access for the OTP memory 10 (e.g., the state 730 of FIG. 7).

In an embodiment, with reference to FIGS. 5 and 10, based on the authenticated authentication status being determined at the stage 1310, at the stage 1330, the processor 140 may store an unlock value (e.g., an ASR unlock value) in the ASR 54. The ASR unlock value may be a value that is opposite from the default value of the ASR 54 in response to the system reset signal. For example, if the default value of the ASR 54 is “0”, then the processor 140 may write the unlock value of“1” into the ASR 54. The write access control circuit 46b or 46d may read the unlock value of the ASR 54 and may generate the write access control circuit output indicating the allowed write access for the OTP memory 10 (e.g., state 830 of FIG. 8).

Additionally, at the stage 1330 and with reference to FIGS. 9 and 10, the processor 140 may write a CAM lock value to the OWR 52c. The write access control circuits 46c, 46d may read the lock value of the OWR 52c and generate the write access control circuit output indicating the disallowed write access for the CAM 20. The locked CAM 20 provides security for the patching table 22 after ROM code execution (i.e., during execution of SBL software or firmware and/or other code executed from on-chip flash 36 and/or off-chip memory 13 subsequent to the stage 1330).

At stage 1335, the method 1300 includes determining an output of a write access control circuit to be indicative of a disallowed write access for the OTP memory. The processor 140 may write lock values to one or more write access control devices OWR 52a and/or patch disable device 325, 525 based on the authentication status of the patch code image 15. The lock values written to the one or more of the write access control devices may determine the output of the write access control circuit 46. The write access control circuit 46 may provide the output based at least in part on the values read from the write access control devices. The processor 140 may determine the provided output to be indicative of the disallowed write access. The processor 140 may perform these operations during ROM code execution.

In an embodiment, with reference to FIGS. 3 and 9, based on the unauthenticated authentication status being determined at the stage 1310, at the stage 1335 the processor 140 may write a lock value (e.g., an OWR lock value) to the OWR 52a. For example, the processor 140 may store the lock value of “0” in the OWR 52a. The write access control circuit 46 may read the lock value from the OWR 52a and generate the write access control circuit output corresponding to the disallowed write access (e.g., the state 770 of FIG. 7).

In an embodiment, with reference to FIGS. 5 and 10, based on the unauthenticated authentication status being determined at the stage 1310, at the stage 1335 the processor 140 may write a lock value (e.g., an OWR lock value) to the OWR 52a (e.g., a first OWR). For example, the processor 140 may store the lock value of “1” in the OWR 52a. The write access control circuit 46 may read the lock value from the OWR 52a and generate the write access control circuit output corresponding to the disallowed write access (e.g., the state 870 of FIG. 8).

Additionally, at the stage 1330 and with reference to FIGS. 9 and 10, the processor 140 may write a CAM lock value to the OWR 52c. The write access control circuits 46c, 46d may read the lock value of the OWR 52c and generate the write access control circuit output indicated the disallowed write access for the CAM 20. The locked CAM 20 provides security for the patching table 22 after ROM code execution (i.e., during execution of SBL software or firmware and/or other code executed from on-chip flash 36 and/or off-chip memory 13 subsequent to the stage 1330).

Subsequent to either of stages 1330 or 1335 and prior to commencing either of stages 1340 or 1350, the processor 140 may complete or otherwise terminate ROM code execution and commence flash code execution (i.e., execution of SBL code stored in on-chip flash memory 36 and/or off-chip memory 13). For example, the PBL firmware may hand over operations of the processor 140 to the SBL software and/or firmware.

At stage 1340, the method 1300 includes storing the patch code from the authenticated patch code image in the OTP memory. For example, the processor 140 may store the patch code in the fuse devices of the OTP memory 10. The processor 140 may store the patch code during flash code execution.

At stage 1350, the method 1300 includes booting the SoC (e.g., executing SBL software or firmware and/or other components of the boot chain sequence) without storing the patch code from the unauthenticated patch code image 15 in the OTP memory 10. The processor may proceed to boot the SoC as similarly as described above with regard to the stage 1250 of the method 1200.

At stage 1360, the method 1300 includes determining the output of the write access control circuit to be indicative of the disallowed write access for the OTP memory. In response to storing the patch code in the patch region 12, the processor 140 may write lock values to one or more write access control devices OWR 52a and/or patch disable device 325, 525. The patch disable device 325, 525 may be OWR 52b or patch disable fuse 18. The write access control circuit 46 may provide an output indicative of a disallowed write access for the OTP memory 10 based on the written lock value. The write access control circuit 46 may provide the output based at least in part on the values read from the write access control devices. The processor 140 may determine the provided output to be indicative of the disallowed write access. The processor 140 may perform these operations during flash code execution.

In an embodiment, with reference to FIGS. 3 and 9, at the stage 1340 in response to storing the patch code in the patch region 12, the processor 140 may store a lock value (e.g., a patch disable device lock value) in the patch disable device 325. For example, the processor 140 may program the patch disable fuse 18. The write access control circuit 46a, 46c may read the lock value of the patch disable device 325 and may generate the write access control circuit output indicating the disallowed write access for the OTP memory 10 (e.g., the state 750 of FIG. 7).

In an embodiment, with reference to FIGS. 5 and 10, at the stage 1340 in response to storing the patch code in the patch region 12, the processor 140 may store a lock value (e.g., a patch disable device lock value) in the patch disable device 525. For example, the processor may program the patch disable fuse 18 and/or write a value to the OWR 52b (e.g., a second OWR). The write access control circuit 46b or 46d may read the lock value of the patch disable device 525 and may generate the write access control circuit output indicating the disallowed write access for the OTP memory 10 (e.g., the state 850 of FIG. 8).

At stage 1370, the method 1300 includes rebooting the SoC 105. For example, as similarly described above with regard to the stage 1270 of the method 1200, the system reset circuit 170 may generate the system reset signal. In response to the system reset signal, the method 1300 may return to the stage 1310.

{{{{{{Other Considerations}}}}}}

Other embodiments are within the scope of the invention. For example, due to the nature of software, functions described above can be implemented using software, hardware, firmware, hardwiring, or combinations thereof. Features implementing functions may also be physically located at various locations, including being distributed such that portions of functions are implemented at different physical locations. Also, as used herein, including in the claims, “or” as used in a list of items prefaced by “at least one of” or “one or more of” indicates a disjunctive list such that, for example, a list of “at least one of A, B, or C” means A or B or C or AB or AC or BC or ABC (i.e., A and B and C), or combinations with more than one feature (e.g., AA, AAB, ABBC, etc.). Also, as used herein, unless otherwise stated, a statement that a function or operation is “based on” an item or condition means that the function or operation is based on the stated item or condition and may be based on one or more items and/or conditions in addition to the stated item or condition. As used herein, including in the claims, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

The terms “machine-readable medium” and “processor-readable storage medium,” as used herein, refer to any medium that participates in providing data that causes a machine to operate in a specific fashion. Using a computer system, various processor-readable media (e.g., a computer program product) might be involved in providing instructions/code to processor(s) for execution and/or might be used to store and/or carry such instructions/code (e.g., as signals). In many implementations, a processor-readable storage medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Common forms of physical and/or tangible processor-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer or processor can read instructions and/or code (i.e., processor-readable).

Various forms of processor-readable media may be involved in carrying one or more sequences of one or more instructions to one or more processors for execution. Merely by way of example, the instructions may initially be carried on a magnetic disk and/or optical disc of a remote computer. A remote computer might load the instructions into its dynamic memory and send the instructions as signals over a transmission medium to be received and/or executed by a computer system.

Information and signals may be represented using any of a variety of different technologies and techniques. For example, data, instructions, commands, information, signals, and symbols that may be referenced throughout the above description may be represented by voltages, currents, electromagnetic waves, magnetic fields or particles, optical fields or particles, or any combination thereof.

The methods, systems, and devices discussed above are examples. Various alternative configurations may omit, substitute, or add various procedures or components as appropriate. Configurations may be described as a process which is depicted as a flow diagram or block diagram. Although each may describe the operations as a sequential process, many of the operations can be performed in parallel or concurrently. In addition, the order of the operations may be rearranged. A process may have additional stages not included in the figure.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional stages or functions not included in the figure. Furthermore, examples of the methods may be implemented by hardware, software, firmware, middleware, microcode, hardware description languages, or any combination thereof. When implemented in software, firmware, middleware, or microcode, the program code or code segments to perform the tasks may be stored in a non-transitory processor-readable medium such as a storage medium. Processors may perform the described tasks.

Components, functional or otherwise, shown in the figures and/or discussed herein as being connected or communicating with each other are communicatively coupled. That is, they may be directly or indirectly connected to enable communication between them.

Having described several example configurations, various modifications, alternative constructions, and equivalents may be used without departing from the disclosure. For example, the above elements may be components of a larger system, wherein other rules may take precedence over or otherwise modify the application of the invention. Also, a number of operations may be undertaken before, during, or after the above elements are considered. Also, technology evolves and, thus, many of the elements are examples and do not bound the scope of the disclosure or claims. Accordingly, the above description does not bound the scope of the claims. Further, more than one invention may be disclosed.

What is claimed is:

1. A method of securely writing patch code to a memory of a system-on-chip (SoC) comprising:
determining an authentication status of a patch code image;
if the authentication status of the patch code image is authenticated, then writing patch code from the patch code image into a one-time programmable (OTP) memory and generating a system reset signal; and
if the authentication status of the patch code image is unauthenticated, then booting the SoC without writing the patch code from the patch code image into the OTP memory.

2. The method of claim 1 further comprising receiving the patch code image post-manufacturing via a signal received at the SoC.

3. The method of claim 1 further comprising, in response to the system reset signal:
executing primary boot loader (PBL) firmware stored in read-only memory; and
replacing at least a portion of the PBL firmware with the patch code written to the OTP memory.

4. The method of claim 1 further comprising determining the authentication status of the patch code image during execution of pre-boot loader code and based at least in part on a digital signature and a public key.

5. The method of claim 1 further comprising:
in response to the writing the patch code into the OTP memory, writing a lock value to at least one of a fuse device or a one-time writable register (OWR); and
determining an output of a write access control circuit to be indicative of a disallowed write access for the OTP memory based on the written lock value.

6. The method of claim 1 further comprising:
if the authentication status of the patch code image is authenticated, then writing an unlock value to at least one one-time writable register (OWR) and determining an output of a write access control circuit to be indicative of an allowed write access for the OTP memory; and
if the authentication status of the patch code image is unauthenticated, then writing a lock value to the at least one one-time writable register (OWR) and determining the output of the write access control circuit to be indicative of a disallowed write access for the OTP memory.

7. The method of claim 1 further comprising:
if the authentication status of the patch code image is authenticated, then writing an unlock value to at least one register and determining an output of a write access control circuit to be indicative of an allowed write access for the OTP memory; and
if the authentication status of the patch code image is unauthenticated, then writing a lock value to at least one one-time writable register (OWR) and determining the output of the write access control circuit to be indicative of a disallowed write access for the OTP memory.

8. The method of claim 1 further comprising:
providing temporarily disabled write access to at least a portion of the OTP memory prior to the determining the authentication status; and
if the authentication status of the patch code image is authenticated, then providing temporarily enabled write access to the at least the portion of the OTP memory.

9. A security system for an electronic device comprising a system-on-chip (SoC), the SoC comprising:
an on-chip memory comprising one-time programmable (OTP) memory;
and
a processor configured to:
determine an authentication status of a patch code image;
if the authentication status of the patch code image is authenticated, then write patch code from the patch code image into a one-time programmable (OTP) memory and generate a system reset signal; and
if the authentication status of the patch code image is unauthenticated, then boot the SoC without writing the patch code from the patch code image into the OTP memory.

10. The SoC of claim 9 further comprising a communications interface configured to receive the patch code image post-manufacturing via a signal received at the SoC.

11. The SoC of claim 9 wherein the processor is further configured to, in response to the system reset signal:
execute primary boot loader (PBL) firmware stored in read-only memory; and
replace at least a portion of the PBL firmware with the patch code written to the OTP memory.

12. The SoC of claim 9 wherein the processor is further configured to determine the authentication status of the patch code image during execution of pre-boot loader code and based at least in part on a digital signature and a public key.

13. The SoC of claim 9 wherein the processor is further configured to:
in response to the patch code being written into the OTP memory, write a lock value to at least one of a fuse device or a one-time writable register (OWR); and
determine an output of a write access control circuit to be indicative of a disallowed write access for the OTP memory based on the written lock value.

14. The SoC of claim 9 wherein the processor is further configured to:
if the authentication status of the patch code image is authenticated, then write an unlock value to at least one one-time writable register (OWR) and determine an output of a write access control circuit to be indicative of an allowed write access for the OTP memory; and
if the authentication status of the patch code image is unauthenticated, then write a lock value to the at least one one-time writable register (OWR) and determine the output of the write access control circuit to be indicative of a disallowed write access for the OTP memory.

15. The SoC of claim 9 wherein the processor is further configured to:
if the authentication status of the patch code image is authenticated, then write an unlock value to at least one register and determine an output of a write access control circuit to be indicative of an allowed write access for the OTP memory; and
if the authentication status of the patch code image is unauthenticated, then write a lock value to at least one one-time writable register (OWR) and determine the output of the write access control circuit to be indicative of a disallowed write access for the OTP memory.

16. The SoC of claim 9 wherein the processor comprises a write access control circuit configured to:
provide temporarily disabled write access to at least a portion of the OTP memory prior to the determination of the authentication status; and
if the authentication status of the patch code image is authenticated, then provide temporarily enabled write access to the at least the portion of the OTP memory.

17. A system-on-chip (SoC) comprising:
means for determining an authentication status of a patch code image;
means for writing patch code from the patch code image into a one-time programmable (OTP) memory and means for generating a system reset signal if the authentication status of the patch code image is authenticated; and
means for booting the SoC without writing the patch code from the patch code image into the OTP memory if the authentication status of the patch code image is unauthenticated.

18. The SoC of claim 17 further comprising means for receiving the patch code image post-manufacturing via a signal received at the SoC.

19. The SoC of claim 17 further comprising:
means for executing primary boot loader (PBL) firmware stored in read-only memory in response to the system reset signal; and
means for replacing at least a portion of the PBL firmware with the patch code written to the OTP memory.

20. The SoC of claim 17 further comprising means for determining the authentication status of the patch code image during execution of pre-boot loader code and based at least in part on a digital signature and a public key.

21. The SoC of claim 17 further comprising:
means for writing a lock value to at least one of a fuse device or a one-time writable register (OWR) in response to the writing the patch code into the OTP memory; and
means for determining an output of a write access control circuit to be indicative of a disallowed write access for the OTP memory based on the written lock value.

22. The SoC of claim 17 further comprising:
means for writing an unlock value to at least one one-time writable register (OWR) and means for determining an output of a write access control circuit to be indicative of an allowed write access for the OTP memory if the authentication status of the patch code image is authenticated; and
means for writing a lock value to the at least one one-time writable register (OWR) and means for determining the output of the write access control circuit to be indicative of a disallowed write access for the OTP memory if the authentication status of the patch code image is unauthenticated.

23. The SoC of claim 17 further comprising:
means for writing an unlock value to at least one register and means for determining an output of a write access control circuit to be indicative of an allowed write access for the OTP memory if the authentication status of the patch code image is authenticated; and
means for writing a lock value to at least one one-time writable register (OWR) and means for determining the output of the write access control circuit to be indicative of a disallowed write access for the OTP memory if the authentication status of the patch code image is unauthenticated.

24. The SoC of claim 17 further comprising:
means for providing temporarily disabled write access to at least a portion of the OTP memory prior to the determining the authentication status; and
means for providing temporarily enabled write access to the at least the portion of the OTP memory if the authentication status of the patch code image is authenticated.

25. A non-transitory, processor-readable storage medium, having stored thereon processor-readable instructions configured to cause a processor to:
determine an authentication status of a patch code image;
if the authentication status of the patch code image is authenticated, then write patch code from the patch code image into a one-time programmable (OTP) memory and generate a system reset signal; and
if the authentication status of the patch code image is unauthenticated, then boot the SoC without writing the patch code from the patch code image into the OTP memory.

26. The non-transitory, processor-readable storage medium of claim 25, the processor-readable instructions being further configured to cause the processor to receive the patch code image post-manufacturing via a signal received at the SoC.

27. The non-transitory, processor-readable storage medium of claim 25, the processor-readable instructions being further configured to cause the processor to, in response to the system reset signal:
execute primary boot loader (PBL) firmware stored in read-only memory; and
replace at least a portion of the PBL firmware with the patch code written to the OTP memory.

28. The non-transitory, processor-readable storage medium of claim 25, the processor-readable instructions being further configured to cause the processor to determine the authentication status of the patch code image during execution of pre-boot loader code and based at least in part on a digital signature and a public key.

29. The non-transitory, processor-readable storage medium of claim 25, the processor-readable instructions being further configured to cause the processor to:
in response to the patch code being written into the OTP memory, write a lock value to at least one of a fuse device or a one-time writable register (OWR); and
determine an output of a write access control circuit to be indicative of a disallowed write access for the OTP memory based on the written lock value.

30. The non-transitory, processor-readable storage medium of claim 25, the processor-readable instructions being further configured to cause the processor to:
if the authentication status of the patch code image is authenticated, then write an unlock value to at least one one-time writable register (OWR) and determine an output of a write access control circuit to be indicative of an allowed write access for the OTP memory; and
if the authentication status of the patch code image is unauthenticated, then write a lock value to the at least one one-time writable register (OWR) and determine the output of the write access control circuit to be indicative of a disallowed write access for the OTP memory.

31. The non-transitory, processor-readable storage medium of claim 25, the processor-readable instructions being further configured to cause the processor to:
if the authentication status of the patch code image is authenticated, then write an unlock value to at least one register and determine an output of a write access control circuit to be indicative of an allowed write access for the OTP memory; and
if the authentication status of the patch code image is unauthenticated, then write a lock value to at least one one-time writable register (OWR) and determine the output of the write access control circuit to be indicative of a disallowed write access for the OTP memory.

32. The non-transitory, processor-readable storage medium of claim 25, the processor-readable instructions being further configured to cause the processor to:
provide temporarily disabled write access to at least a portion of the OTP memory prior to the determination of the authentication status; and
if the authentication status of the patch code image is authenticated, then provide temporarily enabled write access to the at least the portion of the OTP memory.
